(19) United States
(12) Patent Application Publication
(10) Pub. No.: US 2025/0287907 A1
(43) Pub. Date: Sep. 18, 2025

(54) PET WASTE SCOOP ASSEMBLY

(71) Applicant: Towerstar Pets, LLC, Malvern, PA (US)

(72) Inventors: Fernando Becattini, JR., Malvern, PA (US); Jacquelyn N. Becattini, Malvern, PA (US); Fernando Becattini, SR., Devon, PA (US); Ryan Rutherford, Pittstown, NJ (US)

(73) Assignee: Towerstar Pets, LLC, Malvern, PA (US)

(21) Appl. No.: 18/910,169

(22) Filed: Oct. 9, 2024

Related U.S. Application Data
(63) Continuation-in-part of application No. 18/602,825, filed on Mar. 12, 2024.

(51) Int. Cl. A01K 1/01; E01H 1/12

(52) U.S. Cl. CPC A01K 1/0114; E01H 1/1206

(57) ABSTRACT

A pet waste scoop assembly to collect pet waste is provided. The pet waste scoop assembly includes at least a scoop member, a receptacle, and a door. The pet waste scoop assembly may further include a handle. The pet waste scoop assembly may further include a bag. The scoop member may be aligned with a frame to thereby position at least one projection so that the door may freely swing without interruption from the bag that is inserted into the receptacle. The pet waste scoop assembly may be assembled in situ by connecting the scoop member and at least one of a handle and/or an adapter. The pet waste scoop may include tines that extend outward in an angled manner to collect or retrieve the pet waste material.

### CROSS REFERENCE TO RELATED APPLICATIONS

This application is a continuation-in-part application of U.S. patent application Ser. No. 18/602,825, filed on Mar. 12, 2024; the entirety of which is incorporated herein by reference.

### TECHNICAL FIELD

This disclosure is directed to improvements for a pet waste scoop assembly, methods of operation thereof, and methods of manufacture thereof.

### BACKGROUND ART

Ever since humans domesticated dogs and cats and welcomed them into their homes, disposing of their waste products has been an issue. This issue has grown exponentially as more people now live in urban environments than ever before. In many instances pets, particularly cats, are kept indoors at all times and the pets therefore have to utilize litter boxes. Litter boxes are typically filled with specially designed litter materials that form clumps around urine and feces. These litter boxes need to be cleared of pet waste on a regular basis in order to prevent unpleasant odors from overtaking the home. It is needful for the homeowner to remove these pet waste clumps from the litter box to keep the home odor free and so that the cat will continue to use the litter box rather than go elsewhere in the house.

In the case of dogs, many pet owners will either release their animals into a yard to relieve themselves or, if a yard is not available, they will take their dogs on walks for the same purpose. Thus, instead of eliminating in a litter box, dogs may eliminate their waste (i.e., feces and/or urine) on grass, or sand or even concrete. This pet waste also has to be cleaned up.

Each of the Applicant's previously issued patents (i.e., the Incorporated Applications, discussed infra), namely, the '592 Patent, the '873 Patent, and the '825 Patent have addressed various needs of a pet waste scoop assembly.

### SUMMARY OF THE INVENTION

Although each of the Applicant's previously issued patents (i.e., the Incorporated Applications) is extremely beneficial and protects a commercially successful product, there is still room for improvement. Based on Applicant's knowledge in the pet industry, Applicant has recognized the continuing need for improvements to a pet waste scoop assembly. The present disclosure addresses some of these additional needs.

In one aspect, an exemplary embodiment of the present disclosure may provide a pet waste scoop assembly comprising: a scoop member having a frame, wherein the frame has opposing top and bottom walls and opposing first and second sidewalls that collectively provide an inner surface defining a passageway for pet waste material collected by the scoop member to pass through the frame, wherein the opposing top and bottom walls and opposing first and second side walls are arranged in a configuration having a forward end and a rear end; a handle coupled to the scoop member; a receptacle that is engageable with the frame of the scoop member, wherein the receptable includes a wall that lies substantially along a horizontal plane; a door pivotably connected to the frame, wherein the door is movable between an open and closed position, wherein the door moves to the open position in response to moving the scoop member from a generally horizontal orientation toward a generally vertical orientation, and when the door is in the open position, the pet waste material is permitted to move through the passageway and into the receptacle; a plurality of tines on the scoop member that extend outward from the forward end of the frame, wherein the plurality of tines are adapted to permit the scoop member to move through grass; wherein the plurality of tines include: a first tine having a first end and a second end, wherein the first end of the first tine is connected to the frame and the first tine is cantilevered to the second end of the first tine; wherein the first tine comprises: a first section that defines the first end of the first tine that is connected to the frame; and a second section connected to the first section, wherein the second section extends from the first section, and a bottom surface of the second section that lies along a plane that is angled above the horizontal plane.

This exemplary embodiment or another exemplary embodiment of the present disclosure may further provide that the bottom surface of the second section lies along the plane that is angled in a range from about 8 degrees to about 20 degrees above the horizontal plane. This exemplary embodiment or another exemplary embodiment of the present disclosure may further provide that the first tine further comprises: a first section first end and a first section second end, wherein the first section second end is connected to the second section of the first tine, wherein the first section second end is positioned above the first section first end relative to the horizontal plane. This exemplary embodiment or another exemplary embodiment of the present disclosure may further provide that the first tine further comprises: a first section first end and a first section second end, and a bottom surface of the first section that lies along a plane that is angled above the horizontal plane in a range from about 3 degrees to about 12 degrees. This exemplary embodiment or another exemplary embodiment of the present disclosure may further provide that the first tine further comprises: a third section that defines the second end of the first tine, wherein the third section comprises a third section first end and a third second section end, wherein the third section first end is connected to the second section, wherein the third section tapers from the third section first end to the third section second end, wherein the third section second end defines a rounded tip; and wherein the second section is located between the first section and the third section.

This exemplary embodiment or another exemplary embodiment of the present disclosure may further include an imaginary centerline or axis extending vertically and centrally between the forward end and the rear end of the frame when the frame is viewed from a side elevation view; and a door pivotably connected to the frame forward of the imaginary centerline or axis, said door being movable between an open and closed position, wherein the door moves to the open position in response to moving the scoop member from a generally horizontal orientation toward a generally vertical orientation, and when the door is in the open position, the pet waste material is permitted to move through the passageway and into the bag within the receptacle. This exemplary embodiment or another exemplary embodiment of the present disclosure may further include a first side edge of the door that is spaced apart from the first sidewall of the frame when the door is in the closed position; a second side edge of the door that is spaced apart from the second sidewall of the frame when the door is in the closed position; and a lower end of the door that contacts the bottom wall of the frame when the door is in the closed position. This exemplary embodiment or another exemplary embodiment of the present disclosure may further include an angle of inclination of the door relative to horizontal when the door is in the closed position, wherein the angle of inclination is greater than 45 degrees and less than 90 degrees. This exemplary embodiment or another exemplary embodiment of the present disclosure may further include a dimension of the door measured from an upper end of the door to a lower end of the door, wherein when the pet waste scoop assembly is in a vertical orientation with the door in the open position, less than about 50% of the dimension of the door is positioned within the receptacle. This exemplary embodiment or another exemplary embodiment of the present disclosure may further include a first projection located inwardly from the inner surface of the frame, wherein the first projection is configured to extend, at least partially, into the receptacle and displace a portion of a bag in the receptacle thereby enabling the door to move more freely from interruption by the bag in the receptacle. This exemplary embodiment or another exemplary embodiment of the present disclosure may further include a handle receiver on the top wall of the frame; wherein the handle includes a portion that is shaped complementary to the handle receiver to connect the handle with the handle receiver to thereby couple the handle to the scoop member. This exemplary embodiment or another exemplary embodiment of the present disclosure may further provide that the handle receiver comprises: a semi-cylindrical wall extending from an exterior surface of the top wall of the frame; and a receiver top wall positioned atop the semi-cylindrical wall, wherein the receiver top wall overhangs the semi-cylindrical wall.

In yet another aspect, an exemplary embodiment of the present disclosure may provide a pet waste scoop assembly comprising: a scoop member having a frame, wherein the frame has opposing top and bottom walls and opposing first and second sidewalls that collectively provide an inner surface defining a passageway for pet waste material collected by the scoop member to pass through the frame, wherein the opposing top and bottom walls and opposing first and second side walls are arranged in a configuration having a forward end and a rear end; a plurality of tines on the scoop member that extend outward from the forward end of the frame, wherein the plurality of tines are adapted to permit the scoop member to move through grass and retrieve pet waste material; a handle coupled to the scoop member; a receptacle that is engageable with the frame of the scoop member; a bag, wherein the bag comprises, consists of, or consists essentially of paper or wax paper, and the bag is adapted to be inserted into the receptacle to collect pet waste material; and a door pivotably connected to the frame, said door being movable between an open and closed position, wherein the door moves to the open position in response to moving the scoop member from a generally horizontal orientation toward a generally vertical orientation, and when the door is in the open position, the pet waste material is permitted to move through the passageway and into the bag within the receptacle. This exemplary embodiment or another exemplary embodiment of the present disclosure may further provide that the bag further comprises: at least one flap near an open top of the bag, wherein the at least one flap folds over a portion of the receptable when the bag is inserted therein, wherein the at least one flap is interposed between the receptacle and the frame of the scoop member when the scoop member is connected to the frame. This exemplary embodiment or another exemplary embodiment of the present disclosure may further provide that the bag further comprises: a first flap near an open top of the bag, wherein the first flap pivots relative to a first living hinge defined by the bag, and wherein the first flap folds over a first side of the receptable when the bag is inserted therein, wherein the first flap is interposed between the receptacle and the frame of the scoop member when the scoop member is connected to the frame; and a second flap near the open top of the bag, wherein the second flap pivots relative to a second living hinge defined by the bag, and wherein the second flap folds over a second side of the receptable when the bag is inserted therein, wherein the second flap is interposed between the receptacle and the frame of the scoop member when the scoop member is connected to the frame. This exemplary embodiment or another exemplary embodiment of the present disclosure may further provide that the bag further comprises: a third flap near the open top of the bag, wherein the third flap pivots relative to a third living hinge defined by the bag, and wherein the third flap folds over a third side of the receptable when the bag is inserted therein, wherein the third flap is interposed between the receptacle and the frame of the scoop member when the scoop member is connected to the frame; and a fourth flap near the open top of the bag, wherein the fourth flap pivots relative to a fourth living hinge defined by the bag, and wherein the fourth flap folds over a fourth side of the receptable when the bag is inserted therein, wherein the fourth flap is interposed between the receptacle and the frame of the scoop member when the scoop member is connected to the frame. This exemplary embodiment or another exemplary embodiment of the present disclosure may further provide that the bag has a paper thickness that is in a range from about 20 to about 80 grams per square meter (gsm).

In ye another aspect, an exemplary embodiment of the present disclosure may provide a method for a pet waste scoop assembly, the method comprising: inserting a bag into a receptacle, wherein the bag comprises, consists of, or consists essentially of paper or wax paper, and the bag is adapted to collect pet waste material; aligning a scoop assembly having a frame connected with a scoop member with the receptacle, wherein the frame has opposing top and bottom walls and opposing first and second sidewalls that collectively form an inner surface defining a passageway for waste material collected by the scoop member to pass through the frame, wherein the opposing top and bottom walls and opposing first and second side walls are arranged in a configuration having a forward end and a rear end, and a plurality of tines on the scoop member that extend outward from the forward end of the frame, wherein the plurality of tines are adapted to permit the scoop member to move through grass and retrieve pet waste material; connecting a handle to the frame; connecting the frame with the receptacle to interpose a flap on the bag between the frame and the receptacle; moving the tines of the scoop member through grass to collect pet waste material on the tines; and rotating a door pivotably connected with the frame from a closed position to an open closed, wherein the pivotal connection of the door with the frame is located forwardly of an imaginary centerline or axis extending vertically and centrally between the forward end and the rear end of the frame when the frame is viewed from a side elevation view in a horizontal orientation, and when the door is in the open position, the pet waste material is permitted to move through the passageway and into the bag within the receptacle.

This exemplary embodiment or another exemplary embodiment of the present disclosure may further include positioning a first projection that is located inwardly from the inner surface of the frame within the bag and receptacle, wherein the first projection is adapted to permit a door coupled to the frame to freely swing from the closed position to the open position without interruption from the bag in the receptacle; and positioning a second projection that is located inwardly from the inner surface of the frame on an opposite side of the frame from the first projection within the bag and receptacle, wherein the second projection is adapted to permit the door coupled to the frame to freely swing from the closed position to the open position without interruption from the bag in the receptacle. This exemplary embodiment or another exemplary embodiment of the present disclosure may further include orienting the door that is pivotably connected with the frame at a forwardly leaning angle of inclination that is greater than 45 degrees and less than 90 degrees relative to horizontal when the door is in the closed position; and positioning an upper portion of a rear surface of the door directly adjacent the inner surface of the frame when the pet waste scoop assembly is in a vertical orientation with the door in the open position, wherein when the pet waste scoop assembly is in a vertical orientation with the door in the open position less than 50% of a dimension of the door is positioned within the receptacle, wherein the dimension is measured from an upper end of the door to a lower end of the door.

In one aspect, an exemplary embodiment of the present disclosure may provide a pet waste scoop assembly comprising: a scoop member having a frame, wherein the frame has opposing top and bottom walls and opposing first and second sidewalls that collectively provide an inner surface defining a passageway for pet waste material collected by the scoop member to pass through the frame, wherein the opposing top and bottom walls and opposing first and second side walls are arranged in a configuration having a forward end and a rear end; a plurality of tines on the scoop member that extend outward from the forward end of the frame, wherein the plurality of tines are adapted to permit the scoop member to move through grass and retrieve pet waste material; an opening defined near the top wall of the frame; a pole handle that is received in the opening to couple the pole handle to the scoop member; a receptacle that is engageable with the frame of the scoop member; a bag, wherein the bag comprises, consists of, or consists essentially of paper or wax paper, and the bag is adapted to be inserted into the receptacle to collect pet waste material; and a door pivotably connected to the frame, said door being movable between an open and closed position, wherein the door moves to the open position in response to moving the scoop member from a generally horizontal orientation toward a generally vertical orientation, and when the door is in the open position, the pet waste material is permitted to move through the passageway and into the bag within the receptacle. This exemplary embodiment or another exemplary embodiment may further provide that the bag further comprises at least one flap near an open top of the bag, wherein the at least one flap folds over a portion of the receptable when the bag is inserted therein, wherein the at least one flap is interposed between the receptacle and the frame of the scoop member when the scoop member is connected to the frame.

This exemplary embodiment or another exemplary embodiment may further provide that the bag further comprises a first flap near an open top of the bag, wherein the first flap pivots relative to a first living hinge defined by the bag, and wherein the first flap folds over a first side of the receptable when the bag is inserted therein, wherein the first flap is interposed between the receptacle and the frame of the scoop member when the scoop member is connected to the frame; and a second flap near the open top of the bag, wherein the second flap pivots relative to a second living hinge defined by the bag, and wherein the second flap folds over a second side of the receptable when the bag is inserted therein, wherein the second flap is interposed between the receptacle and the frame of the scoop member when the scoop member is connected to the frame. This exemplary embodiment or another exemplary embodiment may further provide that the bag further comprises: a third flap near the open top of the bag, wherein the third flap pivots relative to a third living hinge defined by the bag, and wherein the third flap folds over a third side of the receptable when the bag is inserted therein, wherein the third flap is interposed between the receptacle and the frame of the scoop member when the scoop member is connected to the frame; and a fourth flap near the open top of the bag, wherein the fourth flap pivots relative to a fourth living hinge defined by the bag, and wherein the fourth flap folds over a fourth side of the receptable when the bag is inserted therein, wherein the fourth flap is interposed between the receptacle and the frame of the scoop member when the scoop member is connected to the frame. This exemplary embodiment or another exemplary embodiment may further provide that the bag has a paper thickness that is in a range from about 20 to about 80 grams per square meter (gsm).

This exemplary embodiment or another exemplary embodiment may further include a handle receiver on the top wall of the frame; and an adapter that defines the opening that receives the pole handle, wherein the adapter includes a portion that is shaped complementary to the handle receiver to connect the adapter with the handle receiver to thereby couple the pole handle to the scoop member. This exemplary embodiment or another exemplary embodiment may further provide that the handle receiver comprises a semi-cylindrical wall extending from an exterior surface of the top wall of the frame; and a receiver top wall positioned atop the semi-cylindrical wall, wherein the receiver top wall overhangs the semi-cylindrical wall. This exemplary embodiment or another exemplary embodiment may further provide that the handle receiver defines a C-shaped channel that receives the adapter. This exemplary embodiment or another exemplary embodiment may further provide that the handle receiver defines a horizontally aligned opening that receives the adapter. This exemplary embodiment or another exemplary embodiment may further include a blind hole defined in the top wall of the frame, wherein the blind hole is operatively connected with the handle receiver and the blind holes receives a projection on the adapter to establish a semi-permanent connection subsequent to a one-time in situ assembly of the adapter with the handle receiver.

In yet another aspect, an exemplary embodiment of the present disclosure may provide a pet waste scoop assembly comprising: a scoop member having a frame, wherein the frame has opposing top and bottom walls and opposing first and second sidewalls that collectively provide an inner surface defining a passageway for waste material collected by the scoop member to pass through the frame, wherein the opposing top and bottom walls and opposing first and second side walls are arranged in a configuration having a forward end and a rear end; a plurality of tines on the scoop member that extend outward from the forward end of the frame, wherein the plurality of tines are adapted to permit the scoop member to move through grass; an opening defined adjacent to the top wall of the frame; a pole handle that is received in the opening to couple the pole handle to the scoop member; a receptacle that is engageable with the frame of the scoop member; an imaginary centerline or axis extending vertically and centrally between the forward end and the rear end of the frame when the frame is viewed from a side elevation view; and a door pivotably connected to the frame forward of the imaginary centerline or axis, said door being movable between an open and closed position, wherein the door moves to the open position in response to moving the scoop member from a generally horizontal orientation toward a generally vertical orientation, and when the door is in the open position, the pet waste material is permitted to move through the passageway and into the bag within the receptacle.

This exemplary embodiment or another exemplary embodiment may further include a first side edge of the door that is spaced apart from the first sidewall of the frame when the door is in the closed position; a second side edge of the door that is spaced apart from the second sidewall of the frame when the door is in the closed position; and a lower end of the door that contacts the bottom wall of the frame when the door is in the closed position. This exemplary embodiment or another exemplary embodiment may further include an angle of inclination of the door relative to horizontal when the door is in the closed position, wherein the angle of inclination is greater than 45 degrees and less than 90 degrees. This exemplary embodiment or another exemplary embodiment may further include a dimension of the door measured from an upper end of the door to a lower end of the door, wherein when the pet waste scoop assembly is in a vertical orientation with the door in the open position, less than about 50% of the dimension of the door is positioned within the receptacle. This exemplary embodiment or another exemplary embodiment may further include a first projection located inwardly from the inner surface of the frame, wherein the first projection is configured to extend, at least partially, into the receptacle and displace a portion of a bag in the receptacle thereby enabling the door to move more freely from interruption by the bag in the receptacle. This exemplary embodiment or another exemplary embodiment may further include a handle receiver on the top wall of the frame; and an adapter that defines the opening that receives the pole handle, wherein the adapter includes a portion that is shaped complementary to the handle receiver to connect the adapter with the handle receiver to thereby couple the pole handle to the scoop member. This exemplary embodiment or another exemplary embodiment may further provide that the handle receiver comprises: a semi-cylindrical wall extending from an exterior surface of the top wall of the frame; and a receiver top wall positioned atop the semi-cylindrical wall, wherein the receiver top wall overhangs the semi-cylindrical wall.

In yet another aspect, an exemplary embodiment of the present disclosure may provide a method for a pet waste scoop assembly, the method comprising: inserting a bag into a receptacle, wherein the bag comprises, consists of, or consists essentially of paper or wax paper, and the bag is adapted to collect pet waste material; aligning a scoop assembly having a frame connected with a scoop member with the receptacle, wherein the frame has opposing top and bottom walls and opposing first and second sidewalls that collectively form an inner surface defining a passageway for waste material collected by the scoop member to pass through the frame, wherein the opposing top and bottom walls and opposing first and second side walls are arranged in a configuration having a forward end and a rear end, and a plurality of tines on the scoop member that extend outward from the forward end of the frame, wherein the plurality of tines are adapted to permit the scoop member to move through grass and retrieve pet waste material; connecting a pole handle to the frame; connecting the frame with the receptacle to interpose a flap on the bag between the frame and the receptacle; moving the tines of the scoop member through grass to collect pet waste material on the tines; and rotating a door pivotably connected with the frame from a closed position to an open closed, wherein the pivotal connection of the door with the frame is located forwardly of an imaginary centerline or axis extending vertically and centrally between the forward end and the rear end of the frame when the frame is viewed from a side elevation view in a horizontal orientation, and when the door is in the open position, the pet waste material is permitted to move through the passageway and into the bag within the receptacle. This exemplary embodiment or another exemplary embodiment may further include positioning a first projection that is located inwardly from the inner surface of the frame within the bag and receptacle, wherein the first projection is adapted to permit a door coupled to the frame to freely swing from the closed position to the open position without interruption from the bag in the receptacle; and positioning a second projection that is located inwardly from the inner surface of the frame on an opposite side of the frame from the first projection within the bag and receptacle, wherein the second projection is adapted to permit the door coupled to the frame to freely swing from the closed position to the open position without interruption from the bag in the receptacle. This exemplary embodiment or another exemplary embodiment may further include orienting the door that is pivotably connected with the frame at a forwardly leaning angle of inclination that is greater than 45 degrees and less than 90 degrees relative to horizontal when the door is in the closed position; and positioning an upper portion of a rear surface of the door directly adjacent the inner surface of the frame when the pet waste scoop assembly is in a vertical orientation with the door in the open position, wherein when the pet waste scoop assembly is in a vertical orientation with the door in the open position less than 50% of a dimension of the door is positioned within the receptacle, wherein the dimension is measured from an upper end of the door to a lower end of the door.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top, front perspective view of a first embodiment of a pet waste scoop assembly.

FIG. 2 is a first side elevation view of the first embodiment of the pet waste scoop assembly.

FIG. 3 is an exploded top, front perspective view of the first embodiment of the pet waste scoop assembly.

FIG. 4 is an exploded top, rear perspective view of the first embodiment of the pet waste scoop assembly.

FIG. 5 is a rear elevation view of the scoop member and frame of the first embodiment.

FIG. 6 is a cross section view taken along line 6-6 in FIG. 2.

FIG. 7 is a cross section view taken along line 7-7 in FIG. 1.

FIG. 7A is an enlarged cross section view of the region labeled “SEE FIG. 7A” in FIG. 7.

FIG. 8A is a perspective view of a paper bag that is to be inserted into the receptacle.

FIG. 8B is a perspective view of a paper bag having apertures defined in flaps near the top opening of the bag that is to be inserted into the receptacle.

FIG. 8C is a perspective view of a paper bag having apertures defined in flaps near the top opening of the bag and a sealed or closed lower end of the bag that is to be inserted into the receptacle.

FIG. 9A is an operational perspective view of the paper bag of FIG. 8A being inserted into the receptacle.

FIG. 9B is an operational perspective view of the paper bag of FIG. 8B being inserted into the receptacle.

FIG. 9C is an operational perspective view of the paper bag of FIG. 8C being inserted into the receptacle.

FIG. 10 is an operational perspective view of the paper bag being retained between the frame and the receptacle.

FIG. 11 is a cross section view depending on the paper bag being retained or sandwiched between the frame and the receptacle.

FIG. 12 is a top, front perspective view of a second embodiment of a pet waste scoop assembly having an adapter.

FIG. 13 is an exploded top, front perspective view of the second embodiment of the pet waste scoop assembly having the adapter that connects with a broom handle or pole handle.

FIG. 14 is a top, front perspective view of a third embodiment of a pet waste scoop assembly.

FIG. 15 is an exploded top, front perspective view of the third embodiment of the pet waste scoop assembly.

FIG. 16 is a top, front perspective view of the scoop member from the third embodiment of the pet waste scoop assembly.

FIG. 17 is a side elevation view of the third embodiment of the pet waste scoop assembly depicting the tines being angled above a horizontal plane.

FIG. 18 is an exploded top, front perspective view of the third embodiment of the pet waste scoop assembly having the adapter that connects with a broom handle or pole handle.

Similar numbers refer to similar parts throughout the drawings.

### DETAILED DESCRIPTION

Initially, it is again noted that the present disclosure incorporates by reference each of the Applicant's previously issued U.S. Pat. No. 9,133,592 (the '592 Patent), U.S. Pat. No. 9,428,873 (the '873 Patent), and U.S. Pat. No. 9,661,825 (the '825 Patent) as if fully rewritten, collectively these are referred to as the “Incorporated Applications.” The present disclosure details additional subject matter to the aforementioned and herein incorporated '592 Patent, '873 Patent, and '825 Patent. Namely, the present disclosure is directed a pet waste scoop assembly with the features and components detailed herein, along with methods of operation, and methods of manufacture of the pet waste assembly or its constituent components that were not present in the '592 Patent, the '873 Patent, and the '825 Patent. Since this disclosure incorporates and is generally related to the '592 Patent, the '873 Patent, and the '825 Patent, some similar structural nomenclature is used herein when referencing some portions of the present pet waste scoop assembly and its associated method(s). However, there may be some instances where structural nomenclature differs between similar elements and there may be other instances where nomenclature is similar between distinct elements relative to this disclosure and the '592 Patent, the '873 Patent, and the '825 Patent. Further, there may be instances in this disclosure that utilize similar reference numerals when referencing some portions of the present pet waste scoop assembly and its associated method(s) as in the '592 Patent, the '873 Patent, and the '825 Patent. However, there may also be instances where (i) different reference numerals are utilized herein to refer to similar components as in the '592 Patent, the '873 Patent, and the '825 Patent and/or (ii) similar reference numerals are utilized herein to refer to different components from the '592 Patent, the '873 Patent, and the '825 Patent.

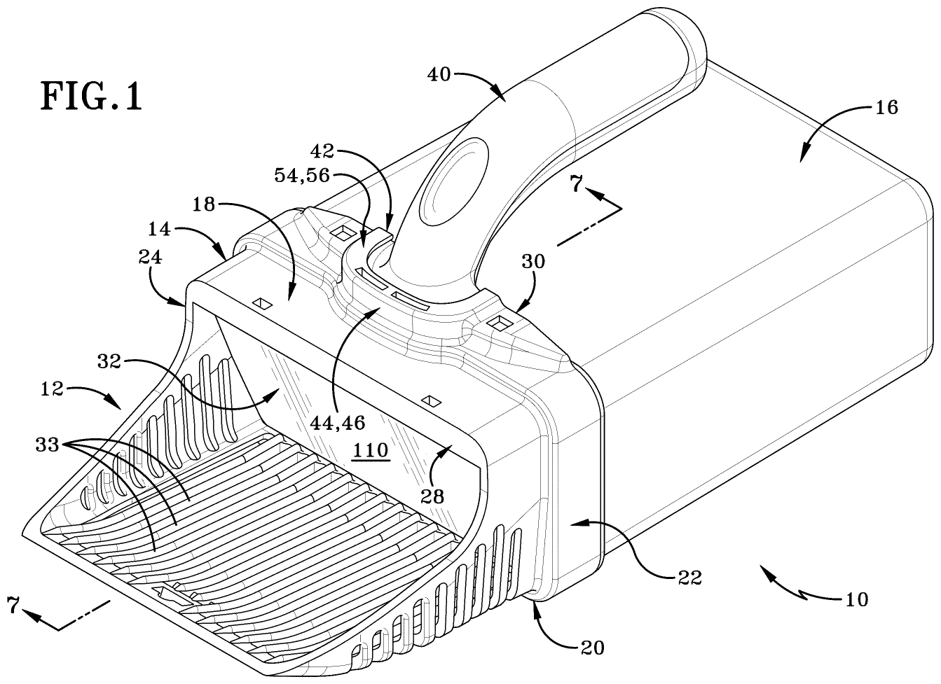

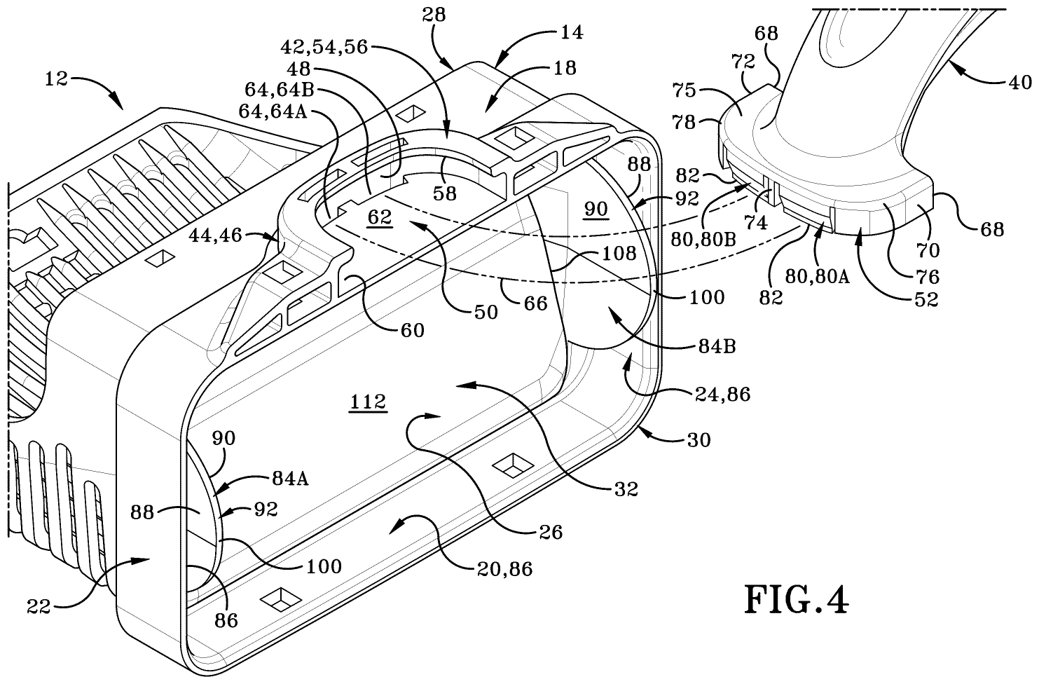

FIG. 1 depicts a pet waste scoop assembly in accordance with one embodiment of the present disclosure generally at 10. Pet waste scoop assembly 10 includes a scoop member 12 having a frame 14 that is configured to releasably connect and/or engage with a receptacle 16. The frame 14 includes a top member or wall 18, a bottom member or wall 20, a first sidewall 22, and a second sidewall 24. The top wall 18, bottom wall 20, first sidewall 22, and second sidewall 24 are generally arranged in a rectangular configuration defining a passageway 26 (see FIG. 4) for waste material collected by the scoop member to pass through the frame 14. The frame 14 includes a forward end 28 and a rear end 30.

A door 32 is pivotably connected to the frame 14. The door 32 may be connected to the frame in a pivotable connection with an upper end 102 of the door 32 being connected with the top wall 18 of frame 14. In one particular embodiment, the door 32 is positioned forwardly of an imaginary center line or axis 36 extending vertically and centrally between the forward end 28 and the rear end 30 of frame 14 when the frame 14 is viewed from a side elevation view.

With continued reference to FIG. 1, it is seen that the scoop member 12 includes a plurality of linear members 33 defining slots therebetween that permit material to fall between the linear members 33 as waste is collected by the scoop member 12. For example, if the pet waste scoop assembly 10 is used in a cat litter box, the pet waste material will be retained by the linear members 33 on the scoop member 12 while permitting litter to be sifted and fall through the slots between the linear members 33. Thereafter, the pet waste scoop assembly 10 may be rotated vertically to allow the pet waste material to move through the passageway 26 and into the internal compartment 34 of receptacle 16. The door 32 pivots open from its closed position in response to the vertical lifting of the pet waste scoop assembly 10, as will be described in greater detail below.

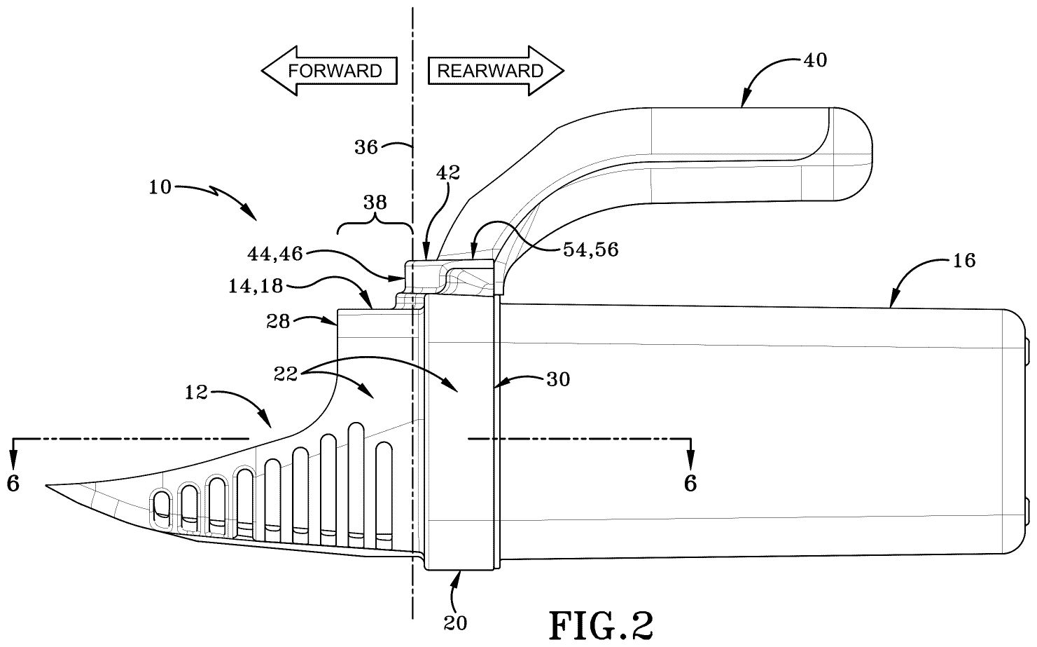

FIG. 2 depicts the imaginary center line or axis 36 that extends vertically and centrally between the forward end 28 and the rear end 30 of the frame 14 when the frame is viewed from a side elevation view. The door 32 has an upper end that is coupled with the top wall 18 of the frame 14 forwardly of axis 36. In FIG. 2, the upper end of the door 32 is connected in the region 38 established forwardly from the axis 36 to the forward end 28. The forward connection of the door 32 to the frame 14 is distinct from previous teachings in which the upper end of the door was coupled rearward of the central axis 36 and more closely adjacent to the rear end 30 of frame 14. One exemplary advantage of coupling the door 32 forwardly of the central axis 36, near the forward end 28 of frame 14, is that it allows the door 32 to occupy less space within the compartment 34 when the door pivots from its closed position to its open position. Stated otherwise, when the door 32 is pivoted open as the pet waste assembly 10 is lifted vertically, the length of the door that extends into the compartment 34 is less than the length of the door that would extend into the compartment if the pivot connection were rearward of axis 36. This results in the bin compartment 34 being able to hold more pet waste. As such, the door has a dimension measured from its upper end to its lower end, wherein when the pet waste scoop assembly 10 is in a vertical orientation with the door in the open position, less than about 50 percent of the total dimension of the door is positioned within the receptacle 34. In another embodiment, less than about 75 percent of this dimension of the door, measured from the upper end to the lower end thereof, is positioned within the receptacle 34 when the pet waste scoop assembly 10 is lifted in a vertical orientation with the door in the open position. This saves a significant amount of space within the receptacle 34 to allow more waste material to be retained therein, thereby providing greater user functionality of the pet waste scoop assembly 10.

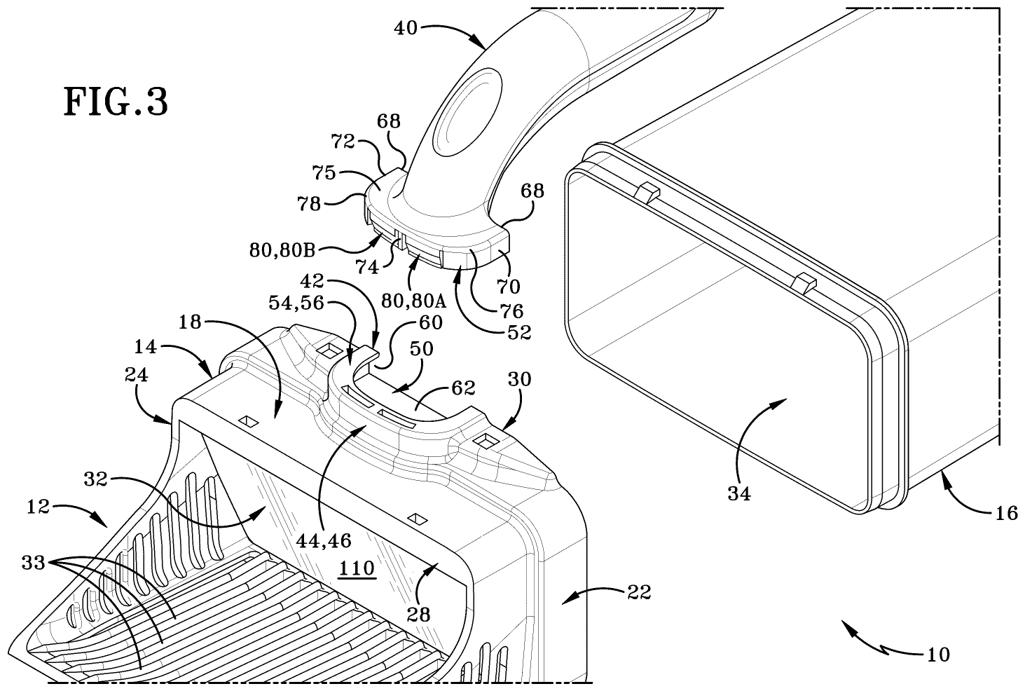

FIG. 2-FIG. 4 depict that the pet waste scoop assembly 10 includes a handle 40 that is coupled to the frame 14 of the scoop 12. The handle 40 may be initially provided separated from the scoop 12 for in situ assembly of the pet waste scoop assembly 10 by the purchaser or user of the scoop assembly 10. The frame 14 includes a handle receiver 42 located on the top wall 18 of frame 14. The handle receiver 42 includes a semi-cylindrical wall 44 that extends upwardly from an exterior surface of the top wall 18 of frame 14. The semi-cylindrical wall 44 includes an exterior surface 46 and an interior surface 48. The interior surface 48 defines a receiving region 50 that is configured to receive an end 52 of handle 40. The receiving region 50 is further defined by a top wall 54 of the handle receiver 42. Top wall 54 is positioned atop the upper end of the semi-cylindrical wall 44 and has a shape similar to that of the profile of the semi-cylindrical wall 44. In one embodiment, the top wall 54 is oriented orthogonal to the semi-cylindrical wall 44. Top wall 54 has an upwardly facing top surface 56 and a downwardly facing bottom surface 58. The bottom surface 58 defines a ledge that overhangs the interior surface 48 of the semi-cylindrical wall 44 to define a channel portion of the receiving region 50. The channel portion is a generally C-shaped channel around the perimeter of the receiving region 50, wherein the C-shaped channel is defined by the interior surface 48 of semi-cylindrical wall 44 and the bottom surface 58 of top wall 54. The channel is configured to receive and retain the end 52 of the handle 40. Collectively, the handle receiver 42 defines the horizontally aligned opening 60 that receives the end 52 of the handle.

FIG. 4 depicts that an exterior surface 62 of the top wall 18 bounds or defines a lower portion of the receiving region 50. Near the forward end of the receiving region 50 is at least one aperture that extends vertically into or through top wall 18. Aperture 64 is configured to receive component on the end 52 of the handle therein for in situ assembly and attachment of the handle 40 to the frame 14. In one particular embodiment, aperture 64 may be a blind aperture that receives a portion or component of the end 52 of the handle 40 for a single-instance of installation. In the shown configuration, there are two blind apertures 64A, 64B. The blind aperture 64 allows the handle 40 to be initially provided to the user separate from the scoop member 12 but allows the user to attach the handle 40 into the receiving region 50 of the receiver 42 for a snap fit connection as indicated by dot-dash line 66. The installation indicated by dot-dash line 66 is meant to depict a single in situ assembly or installation wherein once the handle 40 is connected to the receiver 42, the handle should not or cannot be removed without damaging the pet waste scoop assembly 10. Thus, it is to be understood that once the handle 40 is inserted into the receiver 42, a semi-permanent connection is established.

In situ assembly refers to the manufacturer of the pet waste scoop assembly 10 providing components to the user/customer for them to assemble. In situ assembly refers to the process where the user/customer constructs or puts together the pet waste scoop assembly 10 at its intended location, typically at their own premises. In this context, the manufacturer supplies the necessary components, parts, or modules to the user, and the assembly is carried out by the user at the final destination where the device is intended to be used. This approach may allow for more flexibility in transportation or may reduce shipping costs by lowering fees by enabling smaller packaging boxes to be used (e.g., lowering Fulfillment by Amazon (FBA) fees). The user is responsible for the proper assembly of the components according to provided instructions, ensuring that the device functions as intended once fully assembled. The term emphasizes the location-specific nature of the assembly process, distinguishing it from pre-assembled products that are shipped in their completed form which would require larger boxes and increased shipping fees or FBA fees.

In one embodiment, the end 52 of the handle 40 is shaped complementary to the receiving region 50 of the handle receiver 42. In the shown embodiment, the perimeter of the end 52 of the handle 40 is generally D-shaped. As such, the end 52 of the handle may have a rear flat wall 68, a first sidewall 70, a second sidewall 72, a forward wall 74, and a top wall 75. The first sidewall 70 may meet the forward wall 74 at a generally rounded corner 76 and the second sidewall 72 may meet the forward wall 74 at a generally rounded corner 78. Collectively, the perimeter of the end 52 of the handle 40 is shaped similar to that of the head of a bonnethead shark or a generally spade-like in shape.

There may be at least one connector 80 located at or near the forward wall 74 of the end 52 of handle 40. In the shown embodiment, there is a first connector 80A and a second connector 80B. The connectors 80A, 80B may be downwardly projecting tabs having terminal ends 82 that are configured to fit within the aperture 64 on the receiver 42 when the handle 40 is inserted into the receiving region 50. The connectors 80A, 80B are one-time connectors that establish a single installation of the handle 40 to the frame 14 but substantially preclude the removal of the handle 40 after its connection or installation.

With continued reference to FIG. 4, the pet waste scoop assembly 10 further includes at least one projection located inwardly from an inner surface of the frame 14. The at least one projection is configured to extend, at least partially, into the compartment 34 of receptacle 16 to thereby enable the door 32 to move more freely from interruption by a bag that is within the receptacle 16. The discussion relating to the bag is discussed in greater detail below, however it is to be understood that the purpose of the at least one projection is to inhibit the interference of the bag with the pivoting movement of the door 32 between its open position and its closed position.

FIG. 4 depicts that a first projection 84A is located inwardly from an inner surface 86 of the frame near the first sidewall 22. A second projection 84B is located inwardly from the inner surface 86 of the frame 14 near the second sidewall 24. In one embodiment, each of the projections 84A, 84B is shaped as a lobe or a lug. Each projection 84A, 84B includes an outer surface 88 and an inner surface 90. Each surface 88, 90 may be flat. Alternatively, at least the inner surface 90 on each projection 84A, 84B is flat to permit the door to freely pass thereby. The outer surface 88 of each projection 84A, 84B faces and is spaced slightly apart from the inner surface 86 of frame 14. The respective inner surfaces 90 of the projections 84A, 84B face each other and are located inward from the outer surface 88. Each projection 84A, 84B has a thickness defined by the body of the projection 84A, 84B extending between its outer surface 88 and its inner surface 90.

Each projection 84A, 84B has a perimeter edge 92 that is established by the thickness of the body of each projection 84A, 84B. In one particular embodiment, the perimeter edge 92 of at least one of the projections is semi-circular. In the shown embodiment, the perimeter edge 92 of both projections 84A, 84B is semi-circular. When the scoop member 12 is connected to the receptacle 16, the semi-circular portion of the perimeter edge 92 extends into the compartment 34 of receptacle 16.

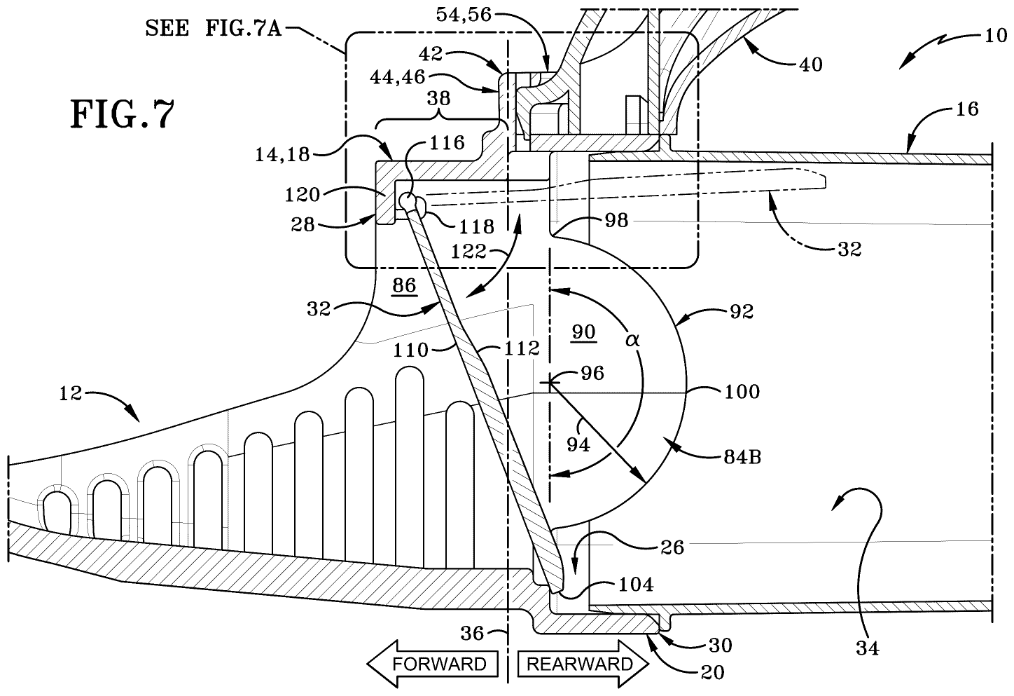

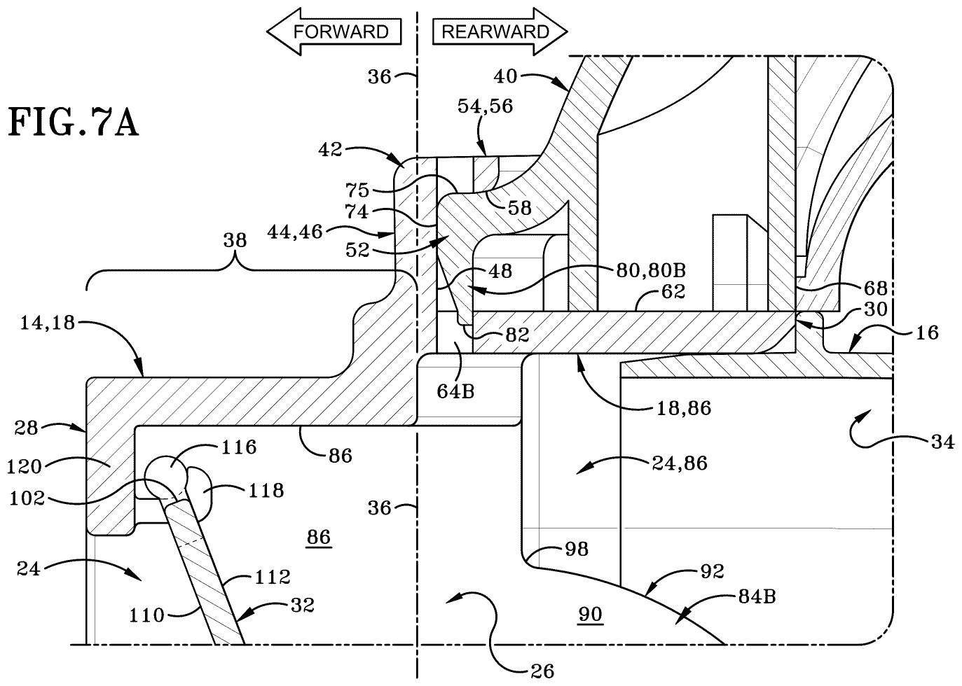

In other embodiments, each of the projections 84A, 84B includes a perimeter edge 92, wherein at least a portion of the perimeter edge 92 is curved. When the perimeter edge 92 is curved, it is the curved portion of the perimeter edge 92 that is located within the compartment 34 of receptacle 16 when the frame 14 and receptacle 16 are engaged together. As show in FIG. 7, when the projections 84A, 84B are semi-circular in shape, the projections 84A, 84B includes a radius of curvature 94 that extends from a point 96 to the perimeter edge 92, wherein the radius of curvature 94 is in a range from about 0.5 inch to about 1.5 inch. In one particular embodiment, the radius of curvature 94 is about one inch. Further, as shown by angle α, the radius of curvature 94 extends approximately 180 degrees about point 96. As such, the perimeter edge 92 extends along an arc length established by the central angle α, wherein the central angle α is approximately 180 degrees.

With respect to each of the projections 84A, 84B, the outer surface 88 establishes a flat first side surface of each projection 84A, 84B and the inner surface 90 establishes a flat second side surface. The perimeter edge 92 is defined by a minimal sidewall established by the thickness of the projection extending between the flat first side surface or outer surface 88 and the flat second side surface or inner surface 90. The area of one of the flat side surfaces is greater than the area of the minimal sidewall defined by the thickness and establishing the perimeter edge 92. Because the sidewalls or the inner and outer surfaces 88, 90 of the projections 84A, 84B are flat, the projections 84A, 84B is rectangular in cross section.

As can be seen in FIG. 4 and FIG. 7, the perimeter edge 92 extends from a forward end 98 and a rear end 100. The forward end 98 of the perimeter edge 92 is connected with the frame 14. The rear end 100 of the projections 84A, 84B is positioned rearward of the rear end 30 of frame 14.

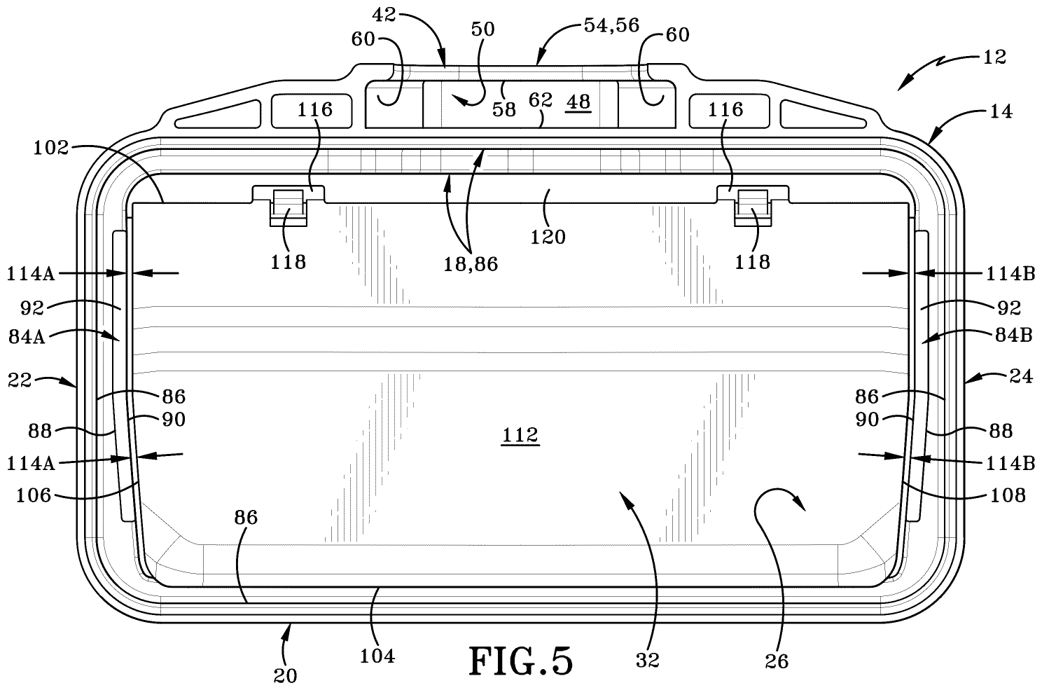

FIG. 5 depicts a rear end elevation view of the scoop member 12 prior to the attachment of handle 40. The door includes an upper end 102 spaced apart from a lower end 104. The door 32 includes a first side edge 106 and a second side edge 108. Collectively, the upper end 102, the lower end 104, the first side edge 106, and the second side edge 108 bound a frontal surface 110 and a rear surface 112 of door 32. The first side edge 106 of the door 32 is spaced apart from the first sidewall 22 of the frame 14 when the door 32 is in the closed position. A small or slight gap 114A is defined between the first side edge 106 and the interior surface 86 of the frame 14. Additionally, the gap 114A may be established between the inner surface or the flat side of the first projection 84A. The slight gap 114A should be small enough to preclude contents stored within the receptacle from exiting but also the gap 114A should be large enough so as not to inhibit free-swinging pivoting movement of the door. Similarly, small or slight gap 114B is defined between the second side edge 108 and the interior surface 86 of the frame 14. The gap 114B may also be defined between the second side edge 108 and the interior surface 90 of the second projection 84B. The lower end 104 of the door 32 contacts the bottom wall 20 of the frame 14 when the door 32 is in the closed position. This prevents the door from pivoting outward or forwardly on the position which is limited by the bottom wall 20 of frame 14.

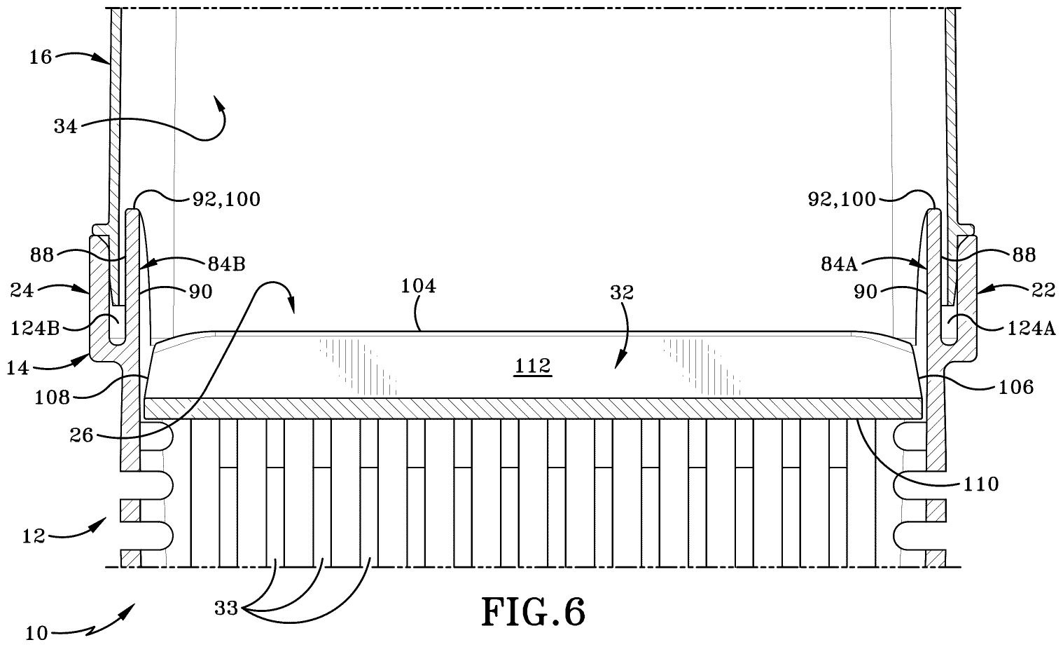

FIG. 6 depicts the scoop member 12 connected with the frame 14. The first sidewall 22 and the second sidewall 24 receive the end of the receptacle 16 therein. A space 124A is defined between the first projection 84A and the first sidewall 22. A space 124B is defined between the second sidewall 24 and the second projection 84B. It is seen that the rear end 100 of the projections 84A, 84B is located within the compartment 34 of receptacle 16.

With continued reference to FIG. 5-FIG. 7A, the upper end 102 of the door 32 may include a pivot connector 116 that connects with a corresponding connection 118 on the top wall 18. As mentioned previously, the door 32 is forwardly biased such that the upper end 102 is positioned forward of the central vertical axis 36. More particularly, the forward end 28 of the top wall 18 may include a downward extension 120. The connector 118 extends rearward from the rear surface of the downward extension 120 and may be shaped similar to that of a hook that is configured to receive the pivot connector 116 at the upper end 102 of the door 32. The rear terminal end of the connector 118 may be forward of the vertical center line 36.

FIG. 7 depicts the door 32 in its closed position. As mentioned previously, the door 32 is able to move between the closed position and the open position as indicated by arrow 122. When the door is in the closed position, the door 32 is forwardly biased at an angle of inclination relative to horizontal. The angle of inclination relative to horizontal is between about 10 degrees and about 80 degrees. In the shown embodiment, the angle of inclination of the door 32 relative to horizontal when the door is in the closed position is greater than 45 degrees but less than 90 degrees. The shown embodiment depicts an angle of inclination of approximately 70 degrees relative to horizontal.

Further, it can be seen that the forwardly biased upper end 102 of the door 32 is positioned forward of the vertical center line 36 and the lower end 104 of the door 32 is positioned rearward of the vertical center line 36 of frame 14. Although the lower end 104 is positioned rearward of the vertical center line 36, it is entirely possible for the lower end 104 of the door to be positioned forward of the vertical center line 36 of frame 14 such that the lower end 104 is in the forward region 38 of the frame 14, similar to that of the upper end 102.

FIG. 7A depicts enlarged cross section view of the handle 40 being connected to the receiver 42. When the end 52 of the handle 40 is inserted into the horizontal slot 60, as indicated by dot-dash line 66 (see FIG. 4), the terminal end 82 of the connector 80 is inserted into the blind hole 64. The end 52 of the handle 40 is inserted sufficiently far into the receiving region 50 such that the forward wall 74 contacts inner surface 48 of wall 44. Additionally, the top surface 75 of the handle may contact the lower surface 58 of the top wall 54. This configuration substantially precludes easy disassembly or removal of the handle 40 from the handle receiver 42 because a lower end of the aperture 64 may be substantially enclosed or covered so as to produce a blind hole. In another embodiment, rather than a blind aperture 64, a similar aperture or depression or cavity could be utilized that facilitates the insertion of the projections 84A, 84B into the cavity that limits the ability for said projections 84 to be removed therefrom.

As shown in FIG. 7A, when the end 52 of the handle 40 is inserted into the receiving region 50 of the handle receiver 42, the end 52 of the handle 40 is positioned rearward or located rearward of the central axis 36. Thus, embodiments of the present disclosure provide for the upper end 102 of the door 32 being positioned forward of the central vertical axis 36 and the handle 40 being located rearward of the central vertical axis 36. Recall, the central vertical axis 36 extends centrally between the forward end 28 and the rear end 30 of the frame 14.

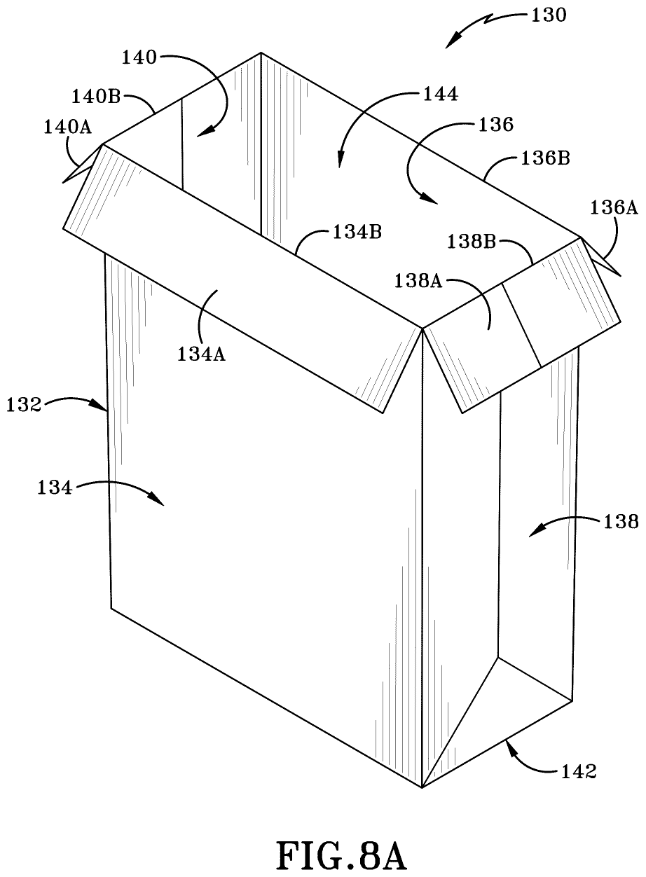

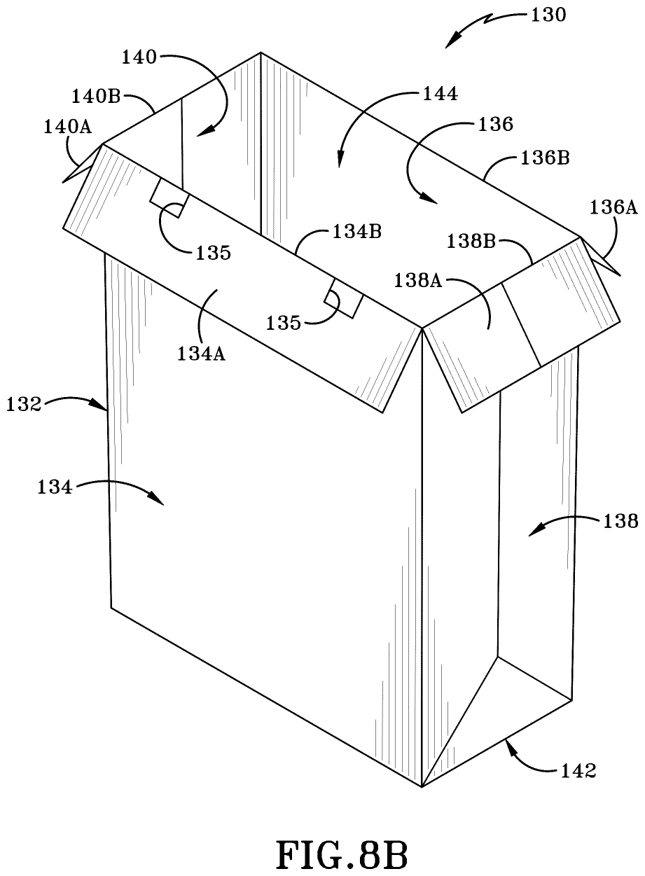

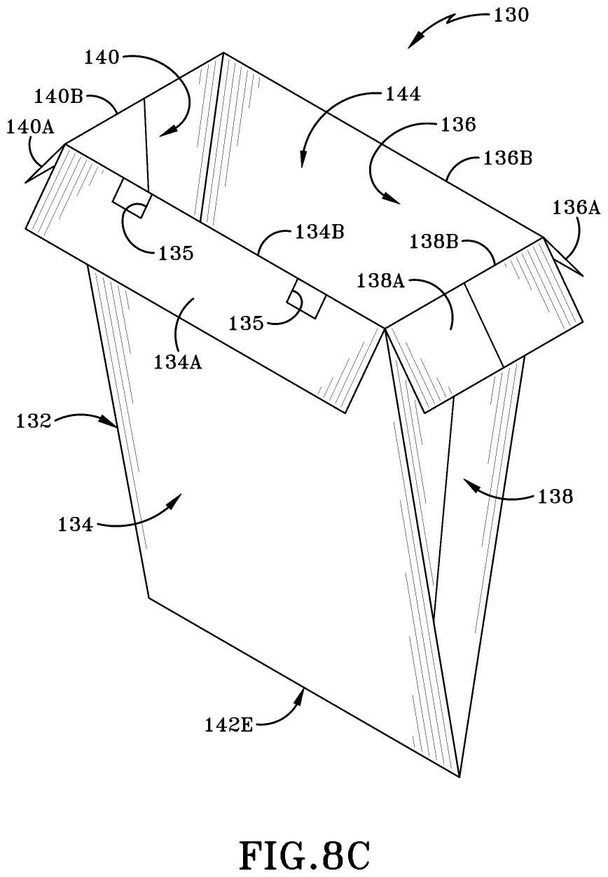

FIG. 8A depicts a pet waste bag 130. The bag 130 has a bag body 132 which may have a first panel 134 and a second panel 136. There may be a first side panel 138, a second side panel 140, and a bottom panel 142. The bag body 132 defines a top opening 144 and has an enclosed bottom end because of bottom panel 142. There may be a flap 134A formed at the top of panel 134 that folds or pivots about a living hinge defined by a folded edge 134B that defines a portion of the top opening 144. There may be a flap 136A formed at the top of panel 136 that folds or pivots about a living hinge defined by a folded edge 136B that defines a portion of the top opening 144. There may be a flap 138A formed at the top of panel 138 that folds or pivots about a living hinge defined by a folded edge 138B that defines a portion of the top opening 144. There may be a flap (not shown) formed at the top of panel 140 that folds or pivots about a living hinge defined by a folded edge 140B that defines a portion of the top opening 144. These flaps are configured to fit over the opening to compartment 34 of receptacle 16 so that they are sandwiched between the frame 14 and the receptacle 16. This retains the bag 130 and holds the top opening 144 open so that pet waste can move through the passageway 26 into the bag after being picked up by the scoop member.

Bag 130 may further include a first slit that extends downward from the open top between the frontal or first panel 134 and the first side panel 136, wherein a lower end of the first slit terminates at an upper end of a first edge. A second slit may extend downward from the open top between the frontal or first panel 134 and the second side panel 140, wherein a lower end of the second slit terminates at an upper end of a second edge. A third slit may extend downward from the open top between the rear or second panel 136 and the first side panel 134, wherein a lower end of the third slit terminates at an upper end of a third edge. A fourth slit may extend downward from the open top between the rear panel and the second side panel, wherein a lower end of the fourth slit terminates at an upper end of a fourth edge.

The horizontal fold 134B extends along the front panel between the first edge and the second edge adjacent to the open top, wherein the horizontal fold defines the living hinge that permits the first flap 134A to pivot. The horizontal second fold 136B extends along the rear panel or second panel 136 between third edge and the fourth edge adjacent the open top, wherein the horizontal second fold 136B defines the living hinge that permits the second flap 136A to pivot. The horizontal third fold 138B extends along the first side panel 138 between first edge and the third edge adjacent the open top, wherein the horizontal third fold 138B defines the living hinge that permits a third flap 138A to pivot. The horizontal fourth fold 140B extends along the second side panel 140 between second edge and the fourth edge adjacent the open top, wherein the horizontal fourth fold defines the living hinge that permits a fourth flap fold to pivot. The paper bag 130 is sized for insertion into a receptacle 16 such that the first flap, the second flap, the third flap, and the fourth flap fold outward and over respective sides of the receptacle to retain the open top.

At least one of the first side panel 138, the second side panel 140, and/or the bottom panel 142 may be gusseted. Incorporating either gusseted sidewalls (e.g. first side panel 138 or second side panel 140), a gusseted bottom (e.g., bottom panel 142), or both into a paper pet waste bag body 132 can enhance the bag's functionality, especially during the insertion process and the waste capture process, which is described in greater detail herein. These design features provide added flexibility, strength, and convenience, making it easier for pet owners to manage and retain the bag 130 inside the container 16 for retaining up their pet's waste.

One embodiment of the present disclosure depicts the bag 130 with both gusseted sidewalls (e.g. first side panel 138 or second side panel 140) and a gusseted bottom (e.g., bottom panel 142). However, another embodiment of the present disclosure depicts the carrier with gusseted sidewalls (e.g. first side panel 138 or second side panel 140) and a non-gusseted bottom panel. Additionally, while not shown in the Figures, it is possible to have another embodiment that has non-gusseted sidewalls and a gusseted bottom panel.

The term “gusset” or “gusseted” refer to additional folds or pleats on the sides of the bag body 132 that expand when the bag is deployed. In the context of the pet waste bag, gusseted sidewalls contribute to increased volume and depth, providing more space for waste without compromising the bag's structural integrity, yet still allowing the bag to be folded into a small space prior to deployment. A gusseted bottom panel 142 may create a broader and more stable foundation when inserted into the compartment 34 of receptacle 16.

Further, although the Figures show a single crease or edge defining the gusset on each side or bottom panel, it is possible for there to be multiple gusseted walls. This would result in a bag with an accordion or concertina shape, where the sides of the bag can expand and contract, based on multiple folds. This design would also provide flexibility in adjusting the bag size based on the amount of waste being collected.

The size parameters of an exemplary pet waste bag depend on various factors, including the intended use, the size of the pets, the size of the receptacle 16, and user preferences. In one exemplary embodiment, the pet waste bag 130 should be of sufficient size to comfortably accommodate the waste produced by different sizes of pets but still fit within the compartment 34 of receptacle 16. The pet waste bag 130 of the present disclosure may be provided in a folded form for convenient dispensing. The size bag when in this compact folded state should be practical for easy storage and dispensing. It is likely that the bag 130 will be provided in a folded configuration when the bag 130 is made from paper so that the user can unfold the bag 130 for deployment and insertion into the receptacle 16. In a commercial context, the folded bag 130 would be sold and provided with a plurality of other identically configured bags 130 that the user will be able to extract from a larger package one-at-a-time, usually when their pet is ready for a walk. Although the folded configuration of the bag 130 is most likely, the bag 130 could also be provided to the user in a rolled configuration. If provided in a rolled configuration roll, then the size parameters should also ensure that the bags are easily dispensed. Further alternatively, the pet waste bags of the present disclosure may be provided in a flat configuration defining a stack of a plurality of similarly structured distinct bags.

The bag body 132 may be composed of at least one layer of paper material that defines each of the panels 134, 136, 138, 140, and 142. When the bag is in its normal position (i.e., expanded and inserted into the compartment 34 of receptacle 16), the paper material has an exterior surface and an interior surface that defines the interior space or volume of the bag body 132.

The type of paper material commonly used to form bags, similar to paper grocery bags or paper lunch bags, is typically referred to as kraft paper. Kraft paper is a sturdy and versatile material that is well-suited for various packaging applications, including bags for carrying items such as, according to embodiments of the present disclosure, pet waste or pet excrement. Kraft paper may be made from the pulp of softwood trees, typically pine and spruce. The kraft pulping process involves treating wood fibers with chemicals to break down lignin, which strengthens the resulting paper. One of the defining features of kraft paper is its strength. It has good tear resistance and can withstand heavy loads. This durability makes it well-suited for carrying pet excrement without easily tearing or breaking. Kraft paper is highly versatile and can be easily folded, creased, and molded into various shapes, making it ideal for bag-making processes. It provides a good surface for printing or labeling, allowing for customization.

The strength characteristics of kraft paper make it a reliable choice for pet waste bags. While the specific strength can vary based on factors such as the paper's weight and thickness, there are some general features of the strength characteristics of kraft paper used as a pet waste bag.

Tensile strength measures the paper's resistance to a force pulling it apart. Kraft paper is known for its high tensile strength, and pet waste bags made from this material can withstand considerable pulling forces without tearing. This strength is advantageous when pet owners pick up waste, ensuring the bag remains intact during use.

Kraft paper has sufficient tear resistance, making it durable and less prone to tearing when subjected to stress or puncture. This characteristic is particularly valuable in pet waste bags, where tears could result in leakage and compromise the bag's functionality. Burst strength measures a material's ability to withstand pressure or weight. Kraft paper used for pet waste bags typically has good burst strength, allowing it to hold pet waste securely without rupturing, especially when the bag is subject to pressure during handling or disposal. Kraft paper exhibits sufficient fold endurance, meaning it can be folded and creased without weakening or losing its structural integrity. This characteristic is advantageous for the practicality of pet waste bags, as users often fold and manipulate the bags during waste collection and disposal. The coefficient of friction determines the ease with which one surface can slide over another. In the context of pet waste bags, a balanced coefficient of friction ensures that the bags can be easily separated from a stack or roll (which could have perforated ends or simply be rolled together) without sticking together. This is advantageous for convenient and efficient bag dispensing.

The specific strength characteristics of kraft paper that form the pet waste bag of the present disclosure can vary based on factors such as the paper's weight (measured in pounds per ream or grams per square meter) and thickness. Manufacturers may produce different grades of kraft paper to meet specific strength requirements for various applications, including those related to pet waste management. Thus, one exemplary embodiment provides a pet waste bag made from kraft paper that is designed to offer a balance of strength, durability, and environmental friendliness for responsible waste disposal.

The strength characteristics of a paper bag can be influenced by various factors, with the thickness of the paper. In one example, the pet waste bag 130 could have a paper thickness that is in a range from about 20 to about 80 grams per square meter (gsm). These could have some of the following general strength data associated with paper bags within this range.

With respect to tensile strength, a 40 gsm paper could have tensile strength of approximately 15 N (Newtons) per 15 mm width; a 50 gsm paper could have tensile strength of approximately 20 N per 15 mm width; a 60 gsm paper could have a tensile strength of approximately 25 N per 15 mm width; a 70 gsm paper could have a tensile strength of approximately 30 N per 15 mm width; and a 80 gsm paper could have tensile strength of approximately 35 N per 15 mm width.

With respect to burst strength, which measures a material's ability to withstand pressure or weight, a 40 gsm paper could have a burst strength of approximately 200 kPa (Kilopascals); a 50 gsm paper could have a burst strength of approximately 250 kPa; a 60 gsm paper could have a burst strength of approximately 300 kPa; a 70 gsm paper could have a burst strength of approximately 350 kPa; and a 80 gsm paper could have a burst strength of approximately 400 kPa.

With respect to tear resistance, a 40 gsm paper could have a tear resistance of approximately 4 N (Elmendorf tear test); a 50 gsm paper could have a tear resistance of approximately 6 N (Elmendorf tear test); a 60 gsm paper could have a tear resistance of approximately 8 N (Elmendorf tear test); a 70 gsm paper could have a tear resistance of approximately 10 N; a 80 gsm paper could have a tear resistance of approximately 12 N.

With respect to fold endurance, which measures how well the paper maintains its strength after repeated folding, a 40 gsm paper could have a fold endurance of approximately 100 folds (MIT folding endurance test); a 50 gsm paper could have a fold endurance of approximately 150 folds; a 60 gsm paper could have a fold endurance of approximately 200 folds; a 70 gsm paper could have a fold endurance of approximately 250 folds; a 80 gsm paper could have a fold endurance of approximately 300 folds.

Notably, these strength data are general estimates and can vary based on specific paper compositions and manufacturing processes. Additionally, the practical strength of the paper bag is influenced by factors such as its design, construction, and intended use. Manufacturers may adjust these parameters to meet specific requirements for the retrieval of pet waste.

Kraft paper is naturally brown in color. This hue is a result of the pulping process, which retains more of the wood's natural color. The brown color is a characteristic feature of many paper grocery bags and lunch bags. However, if desired, the pet waste bag of the present disclosure may be colored or dyed to be any color to meet the application specific needs of the present disclosure. Further, manufacture indicia or logos can be applied or printed on the bag 130.

Kraft paper is biodegradable and environmentally friendly. It breaks down naturally over time, making it a sustainable choice for single-use applications like the pet waste bag or bag 130 of the present disclosure so as to eliminate environmental impacts of conventional pet waste bags composed of microplastics. Thus, using kraft paper as the bag of the present disclosure aligns with the growing emphasis on reducing environmental impact. Further, kraft paper is readily recyclable. Many recycling facilities accept kraft paper, making it a material that can be easily integrated into recycling streams to further minimize its environmental footprint. This would be beneficial if unused bags were recycled.

In one alternative embodiment the paper bag body 132 may optionally be coated with a wax coating. The kraft paper provides a suitable surface for adhering the protective wax layer. The wax-coated exterior enhances the bag's resistance to moisture, making it suitable for applications like pet waste bags. Given these characteristics, kraft paper strikes a balance between strength, eco-friendliness, and versatility, making it a suitable choice for the production of bags that are environmentally conscious for pet waste management.

Although the bag 130 having bag body 132 has been described with reference to kraft paper. Other types of paper could be used to form bag body 132. For example, the bag body could be made from recycled paper, newsprint paper, cardstock or cardboard paper, bleached white paper, linen paper, or bamboo paper. Still further, other types of biodegradable materials could be used to form the bag body 132. For example, the bag body could be made from cornstarch-based materials, bagasse, cotton canvas, hemp fiber, jute, mushroom mycelium, algae-based materials.

In one embodiment, the bag is formed from paper or wax paper. More particularly, the bag is not formed from plastic as taught in previous pet waste scoop assemblies. Forming the bag from paper or wax paper is not a mere matter of design choice. Utilizing a paper bag or wax-paper bag offers the unique advantage of being able to form the page with the flaps that fold over the receptacle and are held in place (e.g., sandwiched between) when the frame of the scoop member engages the receptacle. Further, paper bags or wax-paper bags offer the unique advantage of being compostable or bio-degradable after disposal, unlike plastic bags.

Having thus described some exemplary structural configurations of pet waste scoop assembly 10, reference is now made to its method of assembly and method of operation. It is initially noted that the components of the pet waste assembly, namely, the scoop member 12, the receptacle 16 and the handle 40, along with optionally providing the bags, can be provided to the purchaser of the product as separate pieces. By separating the pieces from the manufacturer, a smaller shipping container, such as a box, may be utilized to supply the parts and components for in situ assembly of the pet waste scoop assembly 10 by the customer. This should reduce FBA fees or other FOB fees to reduce product packaging.

In one exemplary operation, the pet waste scoop assembly is provided to the customer in a disassembled format. Thus, one exemplary method includes providing a disassembled pet waste scoop assembly comprising the receptacle 16, a scoop assembly having the frame 14 connected with a scoop member 12, and at least one of the handle 40 and an adapter 235 (discussed infra); effecting the frame of the scoop assembly be connected to the receptacle in situ; effecting one of the handle 40 and the adapter 235 to be connected to the frame 14 in situ to thereby establish a semi-permanent connection between (i) the one of the handle and the adapter (discussed infra), and (ii) the frame 14.

Another exemplary embodiment includes installing, in situ, a scoop assembly having the frame 14 connected with the scoop member 12 onto the receptacle 16; and installing, in situ, one of the handle 40 and the adapter 235 onto the frame 14 to thereby establish a semi-permanent connection between (i) the one of the handle and the adapter, and (ii) the frame 14.

FIG. 8B depicts another embodiment of the pet waste bag 130 in which at least one aperture 135 is defined in at least one flap near the open top of the bag. The aperture 135 allows a protrusion 35 to extend through the aperture when the at least one flap is interposed between the receptacle and the frame of the scoop member. In FIG. 8B, the embodiment of bag 130 has two apertures 135 shown on the first flap 134A and two apertures 135 on the second flap 136A. These apertures 135 correspond to the number of protrusions 35 that are present on either the scoop member or the receptacle to allow them to connect together by inserting into corresponding mating apertures (note: the protrusions and mating apertures are shown and labeled in the figures of the Incorporated Applications as protrusions 34 and mating apertures 22). It is to be understood that these protrusions 35 and mating apertures may be reversed such that the protrusions 35 are on the frame and the mating apertures formed in the receptacle. Although, the apertures 135 of bag 130 are shown as being defined by an edge with a rectangular-shaped perimeter, thus resulting in a rectangular-shaped aperture 135, this shape is not so limited. The shape of the aperture 135 can take any form factor that permits the protrusions 35 to extend through the aperture 135. Alternatively, instead of having apertures 135 in the flaps of the bag, it could be possible to make a portion of the flap (e.g., 134A or 136A) thinner to allow the protrusions 35 to puncture the bag when interposing the bag 130 between the receptacle and the frame of the scoop member. Still further, rather than making a portion of the bag thinner, the entirety of the bag could be made from a sufficiently thin paper or wax paper material that would allow the protrusions 35 to puncture the bag when interposing the bag between the receptacle and the frame of the scoop member.

FIG. 8C depicts another embodiment of the bag 130 that is composed of the paper or wax paper material described above. However, the bag 130 shown in FIG. 8C differs in that it eliminates the bottom panel 142. Rather than having a bottom panel 142, the bag 130 shown in FIG. 8C has a sealed bottom end that creates a bottom edge 142E. The bottom edge 142E is created by sealing or connecting the lower ends of panel 134 and panel 136 together.

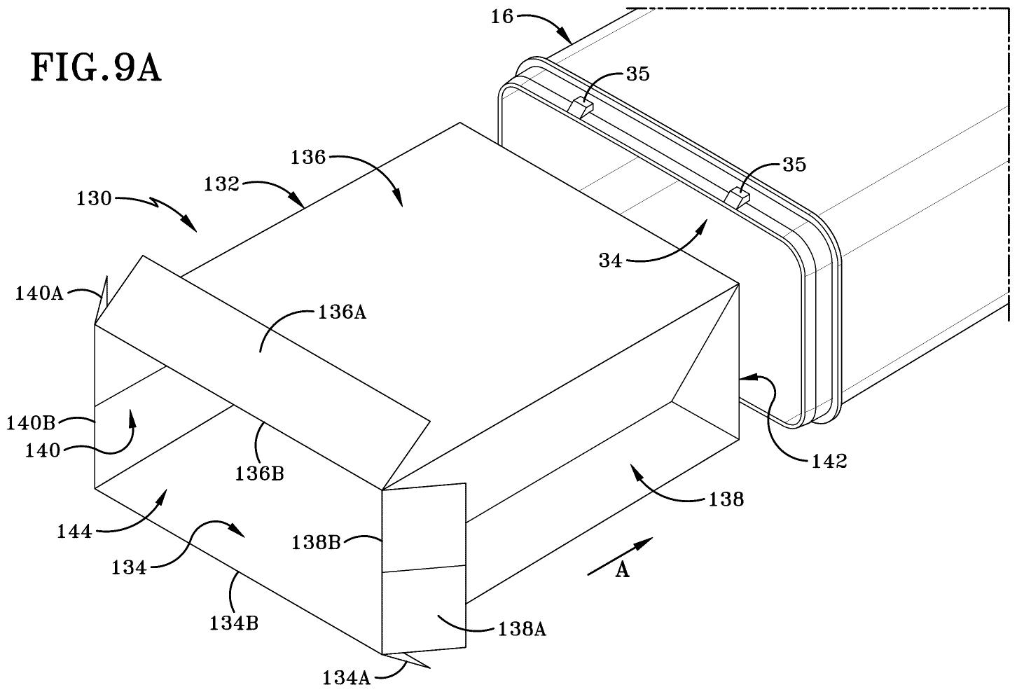

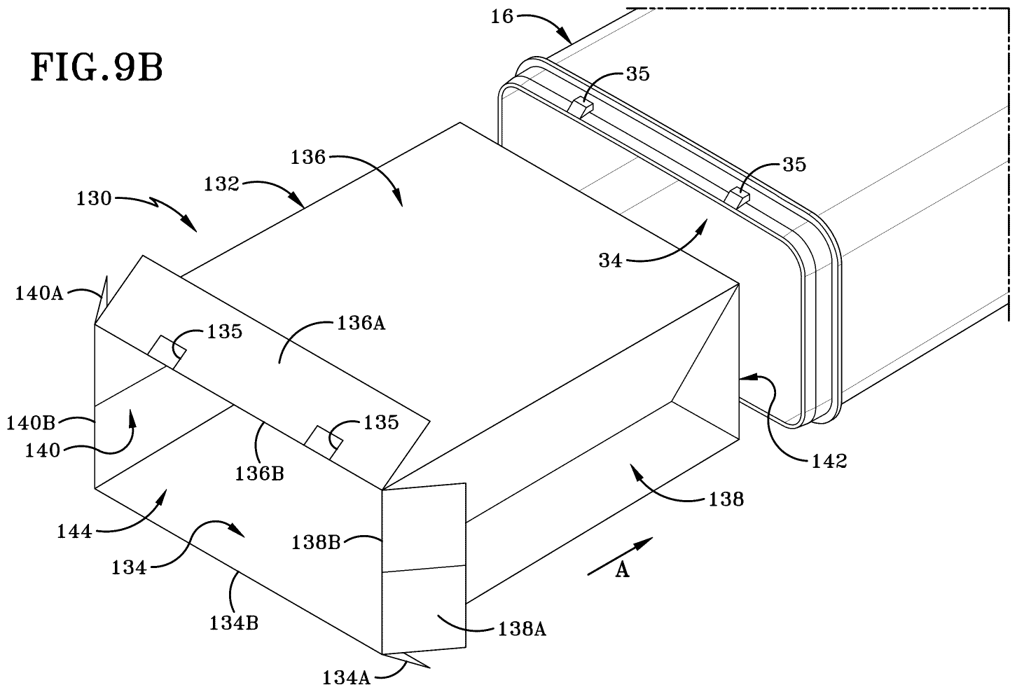

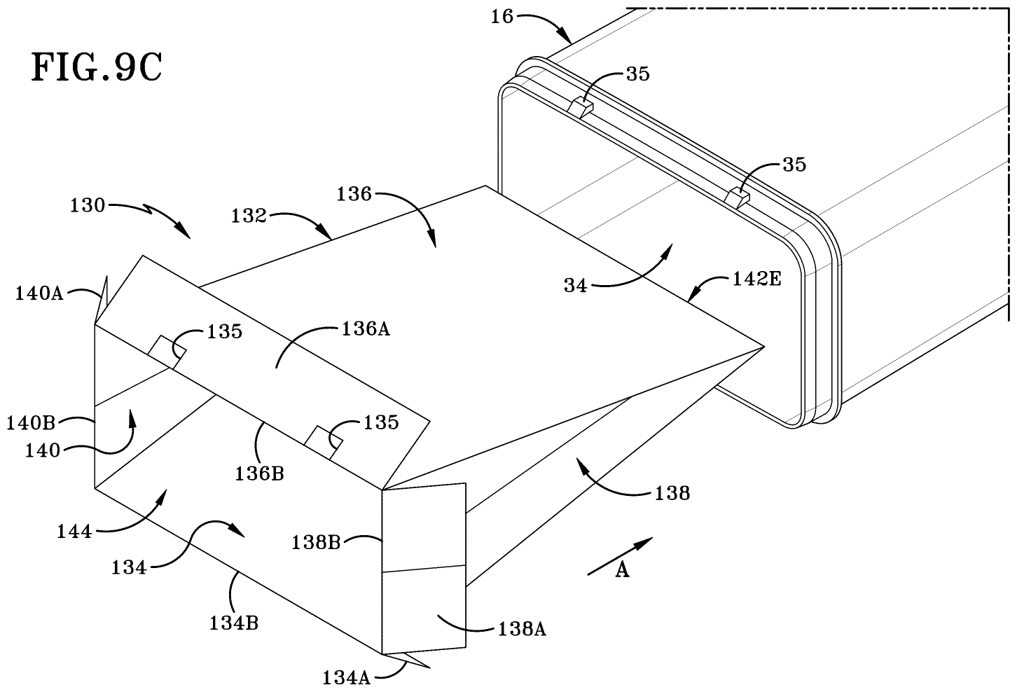

FIG. 9A depicts the insertion of the bag 130 into the receptacle 16. However, it should be noted that prior to insertion of the bag 130 into the receptacle 16, the customer or purchaser of the pet waste scoop assembly 10 will have already installed the handle onto the frame in the manner in which was previously described herein. The bag 130 may be inserted such that the lower or bottom closed end or panel 142 is slid or inserted into the compartment 34 of receptacle 16 as indicated by arrow A. The top opening of the bag 130 is aligned with the opening to the compartment 34. The flaps 134A, 136A, 138A, and 140A on the bag are folded over each of the respective sides of the receptacle 16. With the flaps positioned over the sides of the receptacle 16, the scoop may be moved towards the receptacle 16.

FIG. 9B and FIG. 9C depict an insertion technique of the bag into the receptacle but utilizing the bags 130 shown in FIG. 8B and FIG. 8C, respectively. In these embodiments, the bags 130 should be inserted into the receptacle in a manner that aligns the apertures 135 with the protrusions 35 on the receptacle that insert into the corresponding mating apertures on the frame of the scoop member.

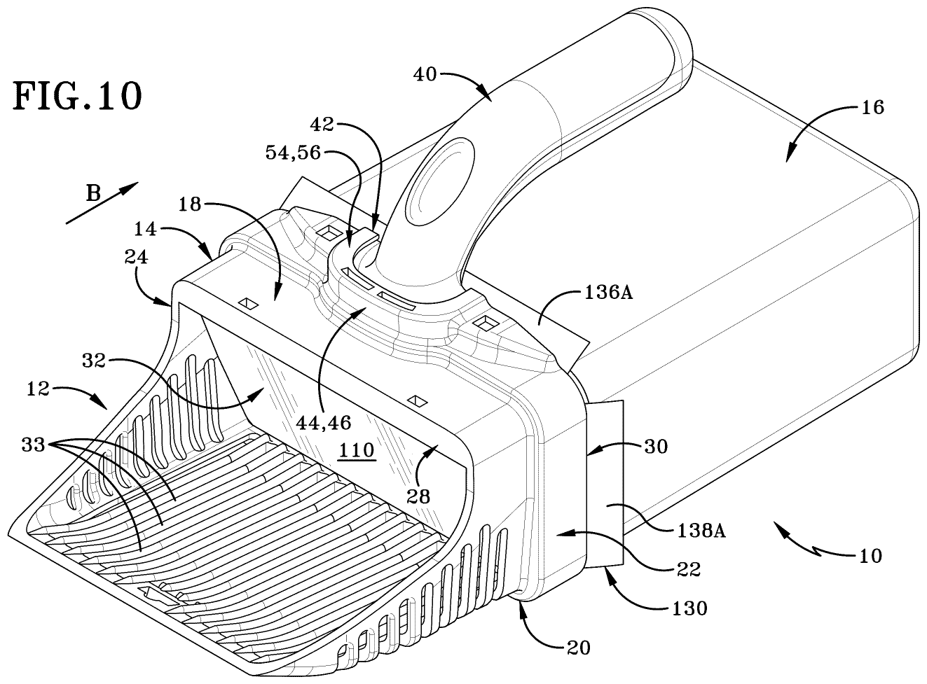

FIG. 10 depicts the connection of the scoop member 12 with the receptacle 16 after having moved the rear end of the frame 14 in the rearward direction as indicated by arrow B. The rear end 30 of the frame 14 nests or mates with the end opening of the receptacle 16. The securement of the frame to the receptacle causes the bag 130, and more particularly the flaps of the bag 130, to be pinched or sandwiched between the frame 14 and the receptacle 16.

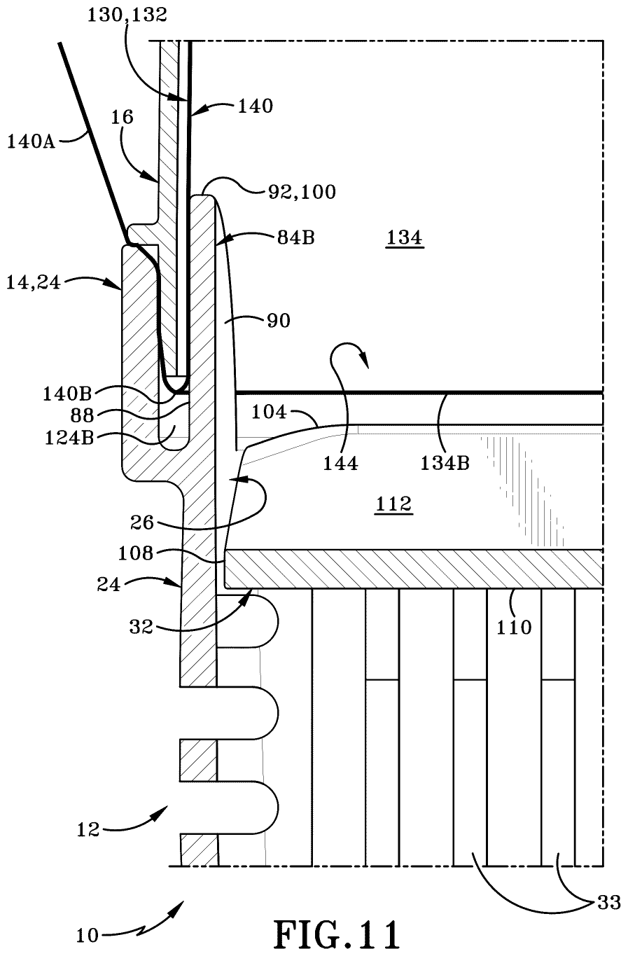

For example, FIG. 11 depicts that the bag 130 is sandwiched or secured within the space 124B located between the projection 84B and the sidewall 24 of the frame 14. The flap of the bag 130 then continues to extend over the exterior surface of the receptacle 16 and is held in place by the snap fit connection of the frame 14 to the receptacle 16.

As is shown in FIG. 11, the location of the projections 84A, 84B holds the bag within the compartment 34 of the receptacle 16 in a position so as not to interfere with the pivoting movement of the door 32. Stated otherwise, the projections 84A, 84B act as a lug or a lobe that holds the bag or retains the bag in an open so as to not disrupt, inhibit, or otherwise impede the pivoting action of the door 32 as the door moves from the closed position to the open position. The door 32 opens as the pet waste scoop assembly 10 is pivoted upward towards the vertical direction by lifting the handle 40 and allowing the door to pivot under the freefall of gravitational forces inwardly into the compartment 34 of receptacle 16 without interruption from the body of the bag.

Having thus described the general operation of pet waste scoop assembly 10, reference now is made to another embodiment of a method or process. One exemplary method may include inserting the bag 130 into the receptacle 16; aligning the frame 14 connected with the scoop member 12 with the receptacle 16; connecting the frame 14 with the receptacle 16; positioning a first projection 84A that is located inwardly from an inner surface of the frame within the bag 130 and receptacle 16, wherein the first projection 84A is adapted to permit the door 32 coupled to the frame 14 to freely swing from a closed position to an open position without interruption from the bag 130 in the receptacle 16. This exemplary method may further provide that positioning the first projection within the bag and receptacle occurs in response to connecting the frame with the receptacle.

This exemplary method may further include positioning the second projection 84B that is located inwardly from the inner surface of the frame 14 on an opposite side of the frame 14 from the first projection 84A within the bag 130 and receptacle 16. The second projection 84B is adapted to permit the door 32 coupled to the frame 14 to freely swing from the closed position to the open position without interruption from the bag in the receptacle.

This exemplary method may further include moving the door 32 coupled to the frame 14 from the closed position to the open position without interruption from the bag 130 in the receptacle 16 in response to rotating the scoop assembly 10 from a generally horizontal orientation toward a generally vertical orientation.

This method also includes trapping the bag 130 between the frame 14 and the receptacle 16 in an open position; collecting pet waste with the scoop member 12; rotating the scoop assembly 10 from a horizontal orientation toward a vertical orientation; pivoting the door 32 to the open position as the scoop assembly is rotated; and sliding captured pet waste down the scoop member 12, wherein the captured pet waste moves past the first projection 84A and into the held-open bag.

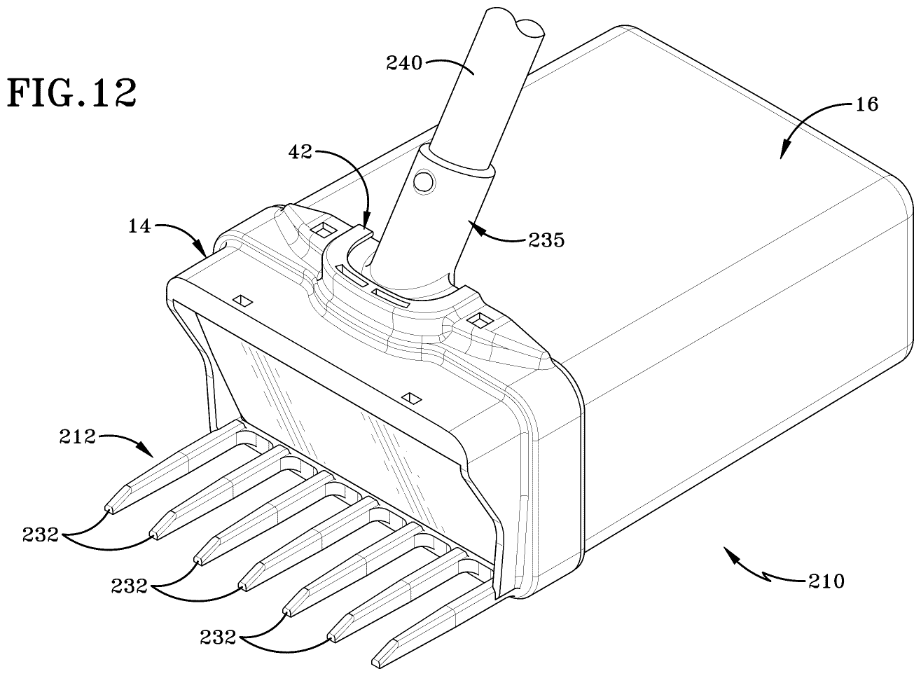

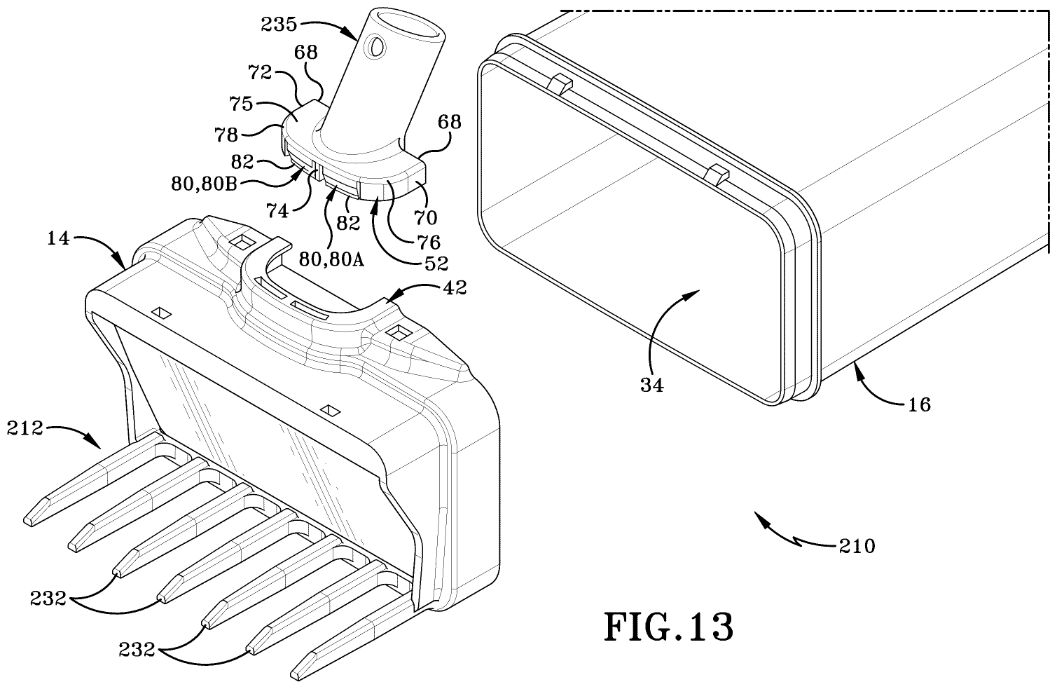

FIG. 12 and FIG. 13 depict an alternative embodiment of a pet waste scoop assembly 210 which has many components similar to that of pet waste scoop assembly 10, and those with similar reference elements are not repeated for brevity. However, assembly 210 utilizes an adapter 235 that connects with the handle receiver 42 on the frame 14 of scoop member 212. The use of the adapter 235 enables a pole handle or broom handle 240 to be connected with the pet waste scoop assembly 210. Adapter 235 has an end 52 that is similar to that which was previously described with respect to handle 40. However, the top end of the adapter 235 has an opening that is configured to receive the lower end of the pole handle or broom handle 240. In one embodiment, the top opening of the adapter 235 may be a threaded opening to threadedly receive the end of the pole or broom handle 240. In another embodiment, the top opening may define an aperture through a sidewall of the adapter 235 that receives a pin on the handle 240 to provide a releasable connection of the handle 240 and the adapter 235. Similar to the other embodiment, once the adapter 235 is intended to be a single time installation, such that the adapter 235 is semi-permanently secured to the handle receiver 42 on frame 14 of scoop assembly 210 once the adapter 235 is installed.

Pet waste scoop assembly 210 includes a plurality of tines 232 that are similar to rake tines to allow the pet waste scoop assembly 210 to better move through grass or other earth and material. This improves the functionality of the scoop assembly 210 by allowing it to operate with pet waste not only from a cat litter box but also from dog waste in grass. Although not shown in FIG. 13, the bag 130 having the flaps detailed herein would also be utilized to be installed within the compartment 34 of receptacle 16 when the adapter 235 is connected with the scoop assembly 210.

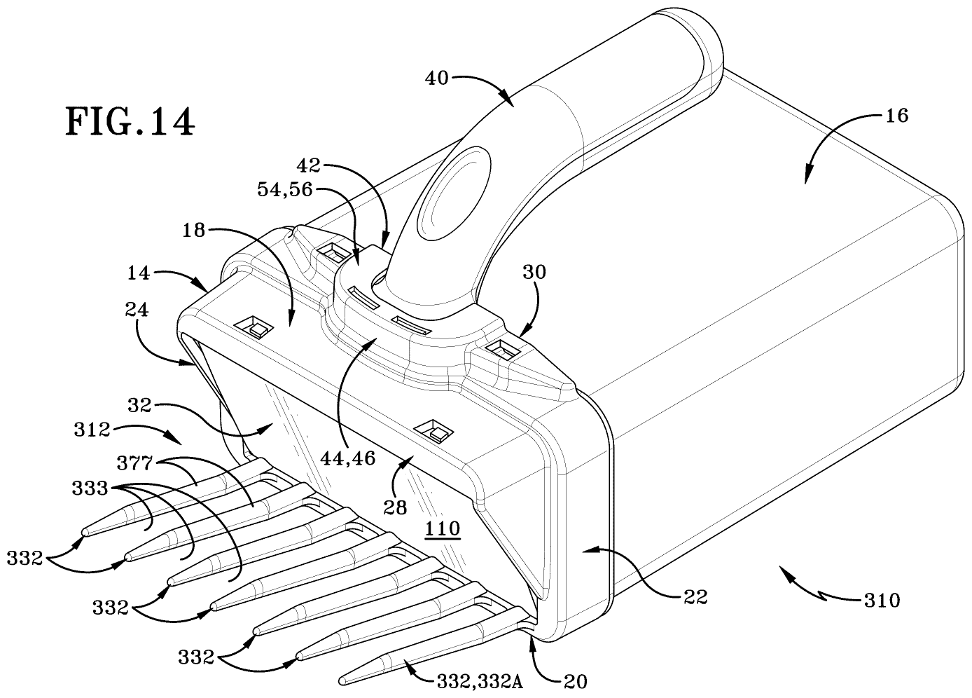

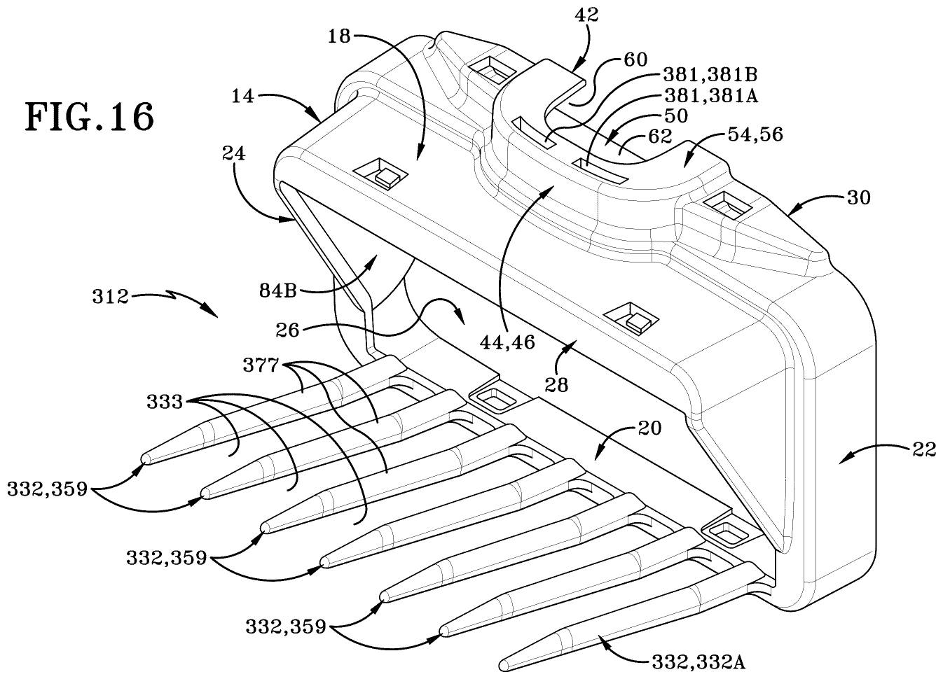

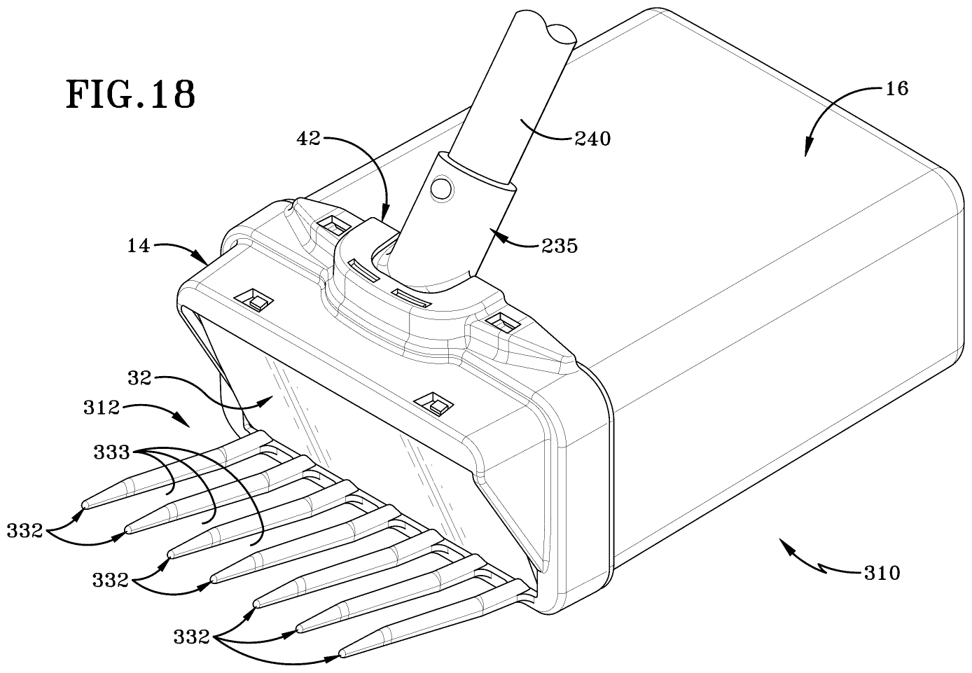

FIG. 14 through FIG. 18 depict an alternative or third embodiment of a pet waste scoop assembly 310, which has many components similar to that of pet waste scoop assembly 10 or pet waste scoop assembly 210, and those similar components with similar reference elements are not repeated for brevity. The scoop member 312 includes frame 14 with a plurality of tines 332 extending forwardly therefrom. In one particular embodiment, the tines 332 extend in a cantilevered manner from the bottom wall 20 of the frame 14. Some portions of the scoop member 312 is similar to the other scoop members 12 or 212 in that the frame 14 has opposing top and bottom walls and opposing first and second side walls that collectively provide an inner surface defining a passageway for pet waste material collected by the scoop member to pass therethrough. As shown in FIG. 14-FIG. 17, the handle 40 is connected to the frame 14 of the scoop member 312. And, as shown in FIG. 18, the adapter 235 may be connected to the frame 14 of scoop member 312 to receive the pole handle 240.

Similar to other embodiments, the scoop member 14 includes the door 32 connected to the frame 14, wherein the door is moveable between an open position and a closed position. The door moves to the open position in response to moving the scoop member 312 from a generally horizontal orientation towards a generally vertical orientation. Then, when the door is in the open position, the pet waste material is permitted to move through the passageway and into the receptacle 16. The upper end of the door 32 is connected to the frame 14 forwardly of the imaginary centerline 36.

The plurality of tines 332 on the scoop member extend outward from the forward end of the frame in a cantilevered manner. The cantilevered tines from the plurality of tines 332 are spaced apart and define spaces or slots 333 there between. In one particular embodiment, the spacing of the plurality of tines 332 permits the scoop member 312 to move through grass and gather pet waste thereon. Although it is primarily envisioned that the plurality of tines 332 are useful to move the scoop assembly 310 through grass, the scoop assembly 310 is not so limited. For example, the plurality of tines 332 would also be useful to scoop pet waste material from carpet, artificial turf, sand, pet litter, dirt, concrete, cement, asphalt or any other surface where an animal has deposited its waste.

In the shown embodiment, the plurality of tines 332 is composed of 7 tines that extend outwardly in a cantilevered manner from the forward end near the bottom of the frame 20. However, the number of tines may vary depending on the application specific needs of the scoop member 312. From the plurality of tines 332, there may be a first tine 332A.

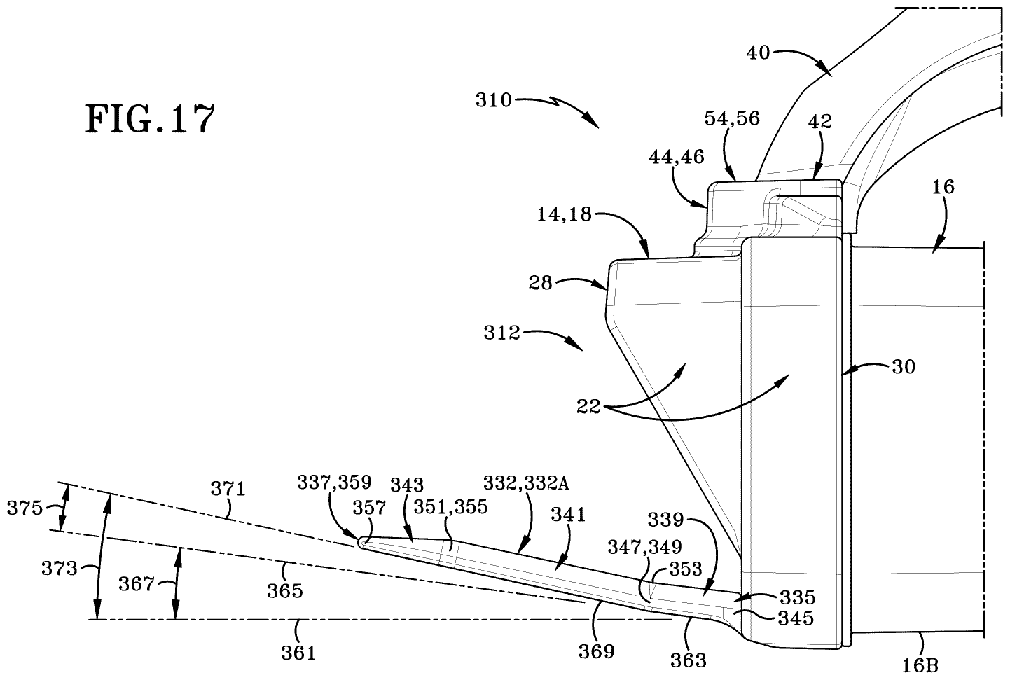

FIG. 17 depicts that the first tine 332A has a configuration that is different from the other embodiments, or the embodiments shown in the Incorporated Applications. First tine 332A includes a first end 335 and a second end 337. The body of the first tine 332A extends from the first end 335 to the second end 337. The length of the body that extends in the cantilevered manner from the first end 335 to the second end 337 may be any length sufficient to meet the application specific needs of collecting pet waste on the plurality of tines 332. However, it is envisioned that the length of each of the tines from the plurality of tines 332 is in a range from about 2 inches to about 6 inches.

Each of the tines from the plurality of tines 332 can be configured in an angled manner relative to the frame 14 or relative other sections or portions of that particular tine. For example, the first tine 332A comprises a first section 339, a second section 341 and a third section 343. The first section 339 of the first tine 332A includes a first section first end 345 and a first section second end 347. The first section first end 345 is coextensive or otherwise defines the first end 335 of the first tine 332A.

The second section 341 of the first tine 332A includes a second section first end 349 and a second section second end 351. The first end 349 of the second section 351 is connected with the second end 347 of the first section 339. The first section second end 347 meets the second section first end 349 at a bend 353.

The third section 343 includes a third section first end 355 and a third section second end 357. The third section first end 355 joins the second section second end 351. The third section second end 357 is coextensive and defines the second end 337 of the first tine 332A. In one particular embodiment, the second end 337 and the third section second end 357 may form a rounded point or a rounded tip 359.

The first tine 332A may have a unique angular orientation that distinguishes the plurality of tines 332 from the previous embodiments. Particularly, the sections 339, 341, and 343 of the first tine 332A are angled in a manner which better permits the scoop assembly 310 to pick up pet waste material when the tines either move through grass or along another surface material. The angular orientations of the sections of the first tine 332A are made with reference to a horizontal plane 361. Recall that the bottom wall 114B of the receptacle 16 is parallel to or coplanar with the horizontal plane 361. With the bottom wall 114B of the receptacle 16 parallel or coplanar with the horizontal plane 361, the first tine 332A has portions or sections thereof that lie along a different plane that is angled above the horizontal plane 361.

For example, and with reference to the first section 339 of the first tine 332A, there is a bottom surface 363 of the first section 339 that lies along a plane 365 to angle the first section 339 above the horizontal plane 361. An angle 367 is defined between the bottom surface 363 of the first section 339 that lies along the plane 365 and the horizontal plane 361. In one particular embodiment, the angle 367 is in a range from about 3 degrees to about 12 degrees. In one particular embodiment, the angle 367 is about 8 degrees. The upward 8-degree inclination of the bottom surface 363 of the first section 339 above the horizontal plane 361 orients the first section second end 347 above the first section first end 345 that is connected to the frame 14. This is remarkably different from the previous embodiments shown herein or in the Incorporated Applications which provide that the first end of the tines is oriented above the second end of the first section. This configuration of pet scoop assembly 310 in which raising the first section second end 347 above the first section first end 345 is useful to assist with moving pet waste through the passageway defined in the frame 14.

The bend 353 defined between the first section 339 and the second section 341 elevates the second section 341 at a greater angle of inclination relative to the horizontal plane 361 than the first section 339. As shown in FIG. 17, the bottom surface 369 of the second section 341 lies along a plane 371 that is angled above the horizontal plane 361. The angle 373 that is defined between the plane 371 and the horizontal plane 361 is in a range from about 8 degrees to about 20 degrees. In one particular embodiment, the angle 373 is about 13 degrees. In another particular embodiment, the angle 373 is about 14 degrees. In yet another embodiment, the angle 373 may be any angle within the range of about 8 degrees to about 20 degrees so long as the angle 373 is greater than the angle 367 that is in a range from about 3 degrees to 12 degrees. Thus, if the first angle 367 is about 8 degrees, then the second angle 373 would be from about 9 degrees to about 20 degrees. The difference between angle 367 and angle 373 is shown by arrow 375 to indicate that the angle 373 is greater than the angle 367, yet both are angled above the horizontal plane 361. In specific embodiment, the difference angle (represented by arrow 375) between angle 367 and angle 373 is about 5 degrees (for example, when angle 367 is 8 degrees and angle 373 is 13 degrees).

In some exemplary embodiments, there may be some advantageous features of the identified ranges of first angle 367, second angle 373, and the different between them (i.e., arrow 375). By configuring the tines 332 within the ranges of these angular orientations above the horizontal plane 361, it has been determined that some exemplary embodiments of scoop member 312 collect or retrieve pet waste without causing the receptacle 16 to contact the ground or other surface material that the pet waste has been deposited. For example, when the tines 332 are angled in the manner taught herein, the user may grasp the handle (e.g., handle 40 or handle 240) and maneuver the tip 359 of the tines 332 downwardly towards the grass or other surface material where the pet waste material is deposited. The angled tines cause the user to maneuver the pet waste assembly 310 downwardly at an angle of descent towards the ground. Then, as the user begins to scoop the pet waste material onto the tines 332, the angle of the tines causes the receptacle to be elevated relative to the grass or ground surface. As the user completes the scooping action, the angled tines enable the receptacle to be located above the ground during the entirety of the scooping action. This is remarkably different than if the bottom of the tines were level or coplanar with the wall 16B on the receptacle 16 because a “straight tine” shall cause the wall 16B on the receptacle 16 to contact the ground or other surface material thereby inhibiting the user's ability to complete the scooping motion or action to fully collect the pet waste. Thus, the upwardly angled tines 332 of scoop assembly 310 enable the receptacle 16 to remain elevated above the ground during the scooping action and prevents the receptacle from bumping into the ground and disrupting the scooping action or motion.

Still further, the angular orientations of the tines 332 have the advantage of biasing the pet waste toward the receptacle 16 and into the internal compartment thereof. As shown in FIG. 17, the distal portion (i.e., second end 351) of the second section 341 is higher or at a greater vertical distance from the horizontal plane 361 than the proximal portion (i.e., first end 349) of the second section 341. Additionally, the distal portion (i.e., second end 347) of the first section 339 is higher or at a greater vertical distance from the horizontal plane 361 than the proximal portion (i.e., first end 345) of the first section 339. This orientation encourages pet waste on the tines 332 to travel or move through the passageway and into the receptacle 16 during the scooping action.

Each of the tines from the plurality of tines 332 may have a generally triangular cross section. However, one remarkable distinct feature of the triangular cross section of the tines 332, such as first tine 332A, is that the upper surface of the triangular cross section may be defined by a rounded point 377 which may be useful to assist with the sliding of pet waste through the frame 14. This is structurally distinct from the previous embodiments which comprised of triangular tines with a sharp and distinct point defining the upper surface of those tines.

Although not shown in FIG. 14-FIG. 18, the bag 130 having flaps detailed herein, would also be utilized to be installed within the compartment of 34 of the receptacle 16 when the handle 40 or the adapter 235 (see FIG. 18) is connected with the scoop assembly 310.

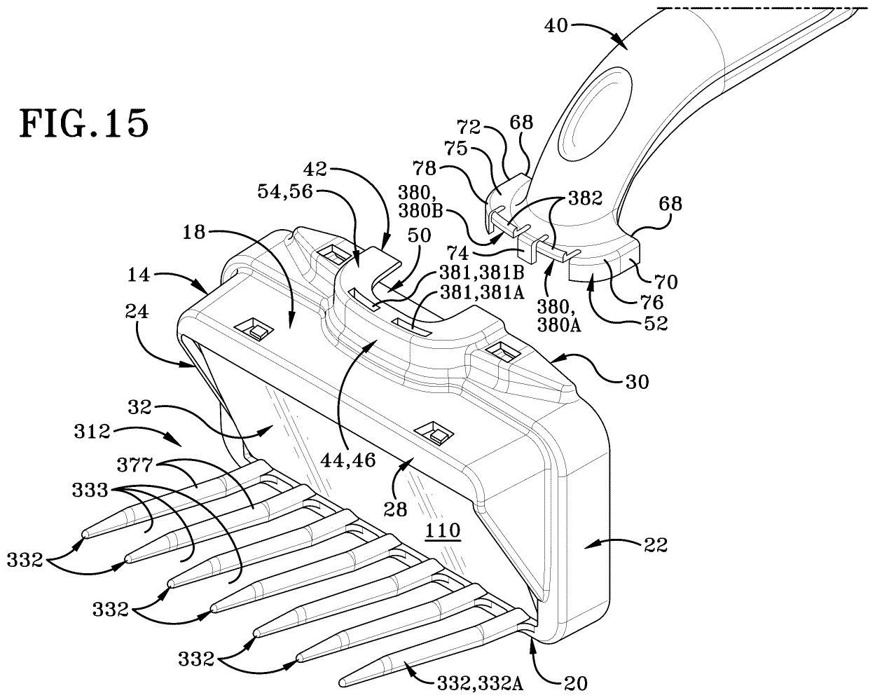

There may be at least one connector 380 located at or near the forward wall 74 of the end 52 of handle 40. In the shown embodiment of FIG. 15, there is a first connector 380A and a second connector 380B. The connectors 380A, 380B may be upwardly projecting tabs having terminal ends 382 that are configured to fit within the apertures 381, namely apertures 381A and 381B, respectively, on the receiver 42 when the handle 40 is inserted into the receiving region 50. The connectors 380A, 380B may be one-time connectors that establish a single installation of the handle 40 to the frame 14 but substantially preclude the removal of the handle 40 after its connection or installation.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible.

For example, instead of the projections 84A, 84B being semi-circular, the first or second projections may be triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration that assists with the door being able to freely pivot or move into the open position without interruption from the bag.

In another example, instead of a portion of the handle receiver 42 being generally C-shaped, a portion of the handle receiver may be semi-circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration that assists with the semi-permanent connection or mating of the handle receiver with the end of the handle or the adapter that receives the handle.

In another example, instead of the end 52 of the handle 40 being generally D-shaped, the end 52 may be semi-circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration that assists with the semi-permanent connection or mating of the handle receiver with the end of the handle or the adapter that receives the handle.

As used herein, the term “semi-permanent” connection refers to a joined configuration between two components (e.g., 1. the handle receiver 42 and the handle 40 or 2. the handle receiver 42 and the adapter 235) where the user assembles them together in situ, typically during the initial setup or installation process upon receiving the pet waste scoop assembly (e.g., after a commercial purchase). Once assembled, these components are intentionally designed to remain connected for an extended period, and the connection should not be easily disassembled or separated without causing permanent damage to the device or the components involved. The intention is to create a durable and stable single or one-time connection that discourages or prevents casual disassembly, ensuring the integrity and functionality of the assembly throughout its intended lifecycle. For example, a semi-permanent connection would not include a handle that is threadedly received into a portion of the pet waste scoop assembly inasmuch as the threaded connection between a handle and scoop assembly permits repeated connection and disconnection without damage to either or both of the components.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A pet waste scoop assembly comprising:
a scoop member having a frame, wherein the frame has opposing top and bottom walls and opposing first and second sidewalls that collectively provide an inner surface defining a passageway for pet waste material collected by the scoop member to pass through the frame, wherein the opposing top and bottom walls and opposing first and second side walls are arranged in a configuration having a forward end and a rear end;
a receptacle that is engageable with the frame of the scoop member, wherein the receptable includes a wall that lies substantially along a horizontal plane;
a door pivotably connected to the frame, wherein the door is movable between an open and closed position, wherein the door moves to the open position in response to moving the scoop member from a generally horizontal orientation toward a generally vertical orientation, and when the door is in the open position, the pet waste material is permitted to move through the passageway and into the receptacle;
a plurality of tines on the scoop member that extend outward from the forward end of the frame, wherein the plurality of tines are adapted collect pet waste material;
wherein the plurality of tines include:
a first tine having a first end and a second end, wherein the first end of the first tine is connected to the frame and the first tine is cantilevered to the second end of the first tine; wherein the first tine comprises:
a first section that defines the first end of the first tine that is connected to the frame;
a second section connected to the first section, wherein the second section extends from the first section, and a bottom surface of the second section that lies along a plane that is angled above the horizontal plane.

2. The pet waste scoop assembly of claim 1, wherein the bottom surface of the second section lies along the plane that is angled in a range from about 8 degrees to about 20 degrees above the horizontal plane.

3. The pet waste scoop assembly of claim 1, wherein the first tine further comprises:
a first section first end and a first section second end, wherein the first section second end is connected to the second section of the first tine, wherein the first section second end is positioned above the first section first end relative to the horizontal plane.

4. The pet waste scoop assembly of claim 1, wherein the first tine further comprises:
a first section first end and a first section second end, and a bottom surface of the first section that lies along a plane that is angled above the horizontal plane in a range from about 3 degrees to about 12 degrees.

5. The pet waste scoop assembly of claim 1, wherein the first tine further comprises:
a third section that defines the second end of the first tine, wherein the third section comprises a third section first end and a third second section end, wherein the third section first end is connected to the second section, wherein the third section tapers from the third section first end to the third section second end, wherein the third section second end defines a rounded tip; and
wherein the second section is located between the first section and the third section.

6. The pet waste scoop assembly of claim 1, further comprising:
an imaginary centerline or axis extending vertically and centrally between the forward end and the rear end of the frame when the frame is viewed from a side elevation view; and
wherein the door is pivotably connected to the frame forward of the imaginary centerline or axis.

7. The pet waste scoop assembly of claim 1, further comprising:
a first side edge of the door that is spaced apart from the first sidewall of the frame when the door is in the closed position;
a second side edge of the door that is spaced apart from the second sidewall of the frame when the door is in the closed position; and
a lower end of the door that contacts the bottom wall of the frame when the door is in the closed position.

8. The pet waste scoop assembly of claim 1, further comprising:
an angle of inclination of the door relative to horizontal when the door is in the closed position, wherein the angle of inclination is greater than 45 degrees and less than 90 degrees.

9. The pet waste scoop assembly of claim 1, further comprising:
a dimension of the door measured from an upper end of the door to a lower end of the door, wherein when the pet waste scoop assembly is in the generally vertical orientation with the door in the open position, less than about 50% of the dimension of the door is positioned within the receptacle.

10. The pet waste scoop assembly of claim 1, further comprising:
a first projection located inwardly from the inner surface of the frame, wherein the first projection is configured to extend, at least partially, into the receptacle and displace a portion of a bag in the receptacle thereby enabling the door to move more freely from interruption by the bag in the receptacle, wherein the bag comprises paper or wax paper, and the bag is adapted to be inserted into the receptacle to collect pet waste material.

11. The pet waste scoop assembly of claim 1, further comprising:
a handle coupled to the frame;
a handle receiver on the top wall of the frame;
wherein the handle includes a portion that is shaped complementary to the handle receiver to connect the handle with the handle receiver to thereby couple the handle to the scoop member;
wherein the handle receiver comprises a semi-cylindrical wall extending from an exterior surface of the top wall of the frame and a receiver top wall positioned atop the semi-cylindrical wall, wherein the receiver top wall overhangs the semi-cylindrical wall.

12. A pet waste scoop assembly comprising:
a scoop member having a frame, wherein the frame has opposing top and bottom walls and opposing first and second sidewalls that collectively provide an inner surface defining a passageway for pet waste material collected by the scoop member to pass through the frame, wherein the opposing top and bottom walls and opposing first and second side walls are arranged in a configuration having a forward end and a rear end;
a receptacle that is engageable with the frame of the scoop member;
a bag, wherein the bag comprises paper or wax paper, and the bag is adapted to be inserted into the receptacle to collect pet waste material; and
a door pivotably connected to the frame, said door being movable between an open and closed position, wherein the door moves to the open position in response to moving the scoop member from a generally horizontal orientation toward a generally vertical orientation, and when the door is in the open position, the pet waste material is permitted to move through the passageway and into the bag within the receptacle.

13. The pet waste scoop assembly of claim 12, wherein the bag further comprises:
at least one flap near an open top of the bag, wherein the at least one flap folds over a portion of the receptable when the bag is inserted therein, wherein the at least one flap is interposed between the receptacle and the frame of the scoop member when the scoop member is connected to the frame.

14. The pet waste scoop assembly of claim 13, wherein an aperture is defined in the at least one flap near the open top of the bag, wherein a protrusion extends through the aperture when the at least one flap is interposed between the receptacle and the frame of the scoop member.

15. The pet waste scoop assembly of claim 12, wherein the bag further comprises:
a first flap near an open top of the bag, wherein the first flap pivots relative to a first living hinge or fold defined by the bag, and wherein the first flap folds over a first side of the receptable when the bag is inserted therein, wherein the first flap is interposed between the receptacle and the frame of the scoop member when the scoop member is connected to the frame; and
a second flap near the open top of the bag, wherein the second flap pivots relative to a second living hinge or fold defined by the bag, and wherein the second flap folds over a second side of the receptable when the bag is inserted therein, wherein the second flap is interposed between the receptacle and the frame of the scoop member when the scoop member is connected to the frame.

16. The pet waste scoop assembly of claim 15, wherein the bag further comprises:
a third flap near the open top of the bag, wherein the third flap pivots relative to a third living hinge or fold defined by the bag, and wherein the third flap folds over a third side of the receptable when the bag is inserted therein, wherein the third flap is interposed between the receptacle and the frame of the scoop member when the scoop member is connected to the frame; and
a fourth flap near the open top of the bag, wherein the fourth flap pivots relative to a fourth living hinge or fold defined by the bag, and wherein the fourth flap folds over a fourth side of the receptable when the bag is inserted therein, wherein the fourth flap is interposed between the receptacle and the frame of the scoop member when the scoop member is connected to the frame.

17. A pet waste scoop assembly comprising:
a scoop member having a frame, wherein the frame has opposing top and bottom walls and opposing first and second sidewalls that collectively provide an inner surface defining a passageway for waste material collected by the scoop member to pass through the frame, wherein the opposing top and bottom walls and opposing first and second side walls are arranged in a configuration having a forward end and a rear end;
a plurality of tines on the scoop member that extend outward from the forward end of the frame, wherein the plurality of tines are adapted to collect pet waste material;
a receptacle that is engageable with the frame of the scoop member;
an imaginary centerline or axis extending vertically and centrally between the forward end and the rear end of the frame when the frame is viewed from a side elevation view; and
a door pivotably connected to the frame forward of the imaginary centerline or axis, said door being movable between an open and closed position, wherein the door moves to the open position in response to moving the scoop member from a generally horizontal orientation toward a generally vertical orientation, and when the door is in the open position, the pet waste material is permitted to move through the passageway and into the bag within the receptacle.

18. A method for a pet waste scoop assembly, the method comprising:
inserting a bag into a receptacle, wherein the bag comprises paper or wax paper, and the bag is adapted to collect pet waste material;
aligning a scoop assembly having a frame connected with a scoop member with the receptacle, wherein the frame has opposing top and bottom walls and opposing first and second sidewalls that collectively form an inner surface defining a passageway for waste material collected by the scoop member to pass through the frame, wherein the opposing top and bottom walls and opposing first and second side walls are arranged in a configuration having a forward end and a rear end, and a plurality of tines on the scoop member that extend outward from the forward end of the frame;
connecting the frame with the receptacle to interpose a flap on the bag between the frame and the receptacle;
collecting pet waste material on the tines; and
rotating a door pivotably connected with the frame from a closed position to an open closed, and when the door is in the open position, the pet waste material is permitted to move through the passageway and into the bag within the receptacle.

19. The method of claim 18, further comprising:
positioning a first projection that is located inwardly from the inner surface of the frame within the bag and receptacle, wherein the first projection is adapted to permit a door coupled to the frame to freely swing from the closed position to the open position without interruption from the bag in the receptacle; and
positioning a second projection that is located inwardly from the inner surface of the frame on an opposite side of the frame from the first projection within the bag and receptacle, wherein the second projection is adapted to permit the door coupled to the frame to freely swing from the closed position to the open position without interruption from the bag in the receptacle.

20. The method of claim 18, further comprising:
wherein the pivotal connection of the door with the frame is located forwardly of an imaginary centerline or axis extending vertically and centrally between the forward end and the rear end of the frame when the frame is viewed from a side elevation view in a horizontal orientation;
orienting the door that is pivotably connected with the frame at a forwardly leaning angle of inclination that is greater than 45 degrees and less than 90 degrees relative to horizontal when the door is in the closed position; and
positioning an upper portion of a rear surface of the door directly adjacent the inner surface of the frame when the pet waste scoop assembly is in a vertical orientation with the door in the open position, wherein when the pet waste scoop assembly is in a vertical orientation with the door in the open position less than 50% of a dimension of the door is positioned within the receptacle, wherein the dimension is measured from an upper end of the door to a lower end of the door.

21. The method of claim 18, wherein connecting the frame with the receptacle to interpose the flap on the bag between the frame and the receptacle further comprises:
positioning a protrusion through an aperture defined in the flap of the bag, wherein the protrusion is located on one of the frame and the receptacle.

22. A pet waste scoop assembly comprising:
a scoop member having a frame, wherein the frame has opposing top and bottom walls and opposing first and second sidewalls that collectively provide an inner surface defining a passageway for pet waste material collected by the scoop member to pass through the frame, wherein the opposing top and bottom walls and opposing first and second side walls are arranged in a configuration having a forward end and a rear end;
a receptacle that is engageable with the frame of the scoop member; and
a bag, wherein the bag comprises paper or wax paper, and the bag is configured to be inserted into the receptacle to collect pet waste material, and wherein the bag further comprises at least one flap near an open top of the bag, wherein the at least one flap folds over a portion of the receptable when the bag is inserted therein, wherein the at least one flap is interposed between the receptacle and the frame of the scoop member when the scoop member is connected to the frame.

23. The pet waste scoop assembly of claim 22, further comprising:
an aperture defined in the at least one flap of the bag, wherein a protrusion extends through the aperture when the bag is interposed between the receptacle and the frame of the scoop member.
